(19) United States
(12) Patent Application Publication
(10) Pub. No.: US 2026/0257640 A1
(43) Pub. Date: Sep. 3, 2026

(54) REAR IMPACT UNIT

(71) Applicant: ACPS Automotive GmbH, Ingersheim (DE)

(72) Inventor: Martin Krause, Moeglingen (DE)

(73) Assignee: ACPS Automotive GmbH, Ingersheim (DE)

(21) Appl. No.: 19/548,005

(22) Filed: Feb. 24, 2026

(30) Foreign Application Priority Data
Mar. 3, 2025 (DE) 10 2025 108 008.9
Jun. 3, 2025 (DE) 10 2025 121 670.3

(51) Int. Cl. B60R 19/34; B60D 1/06; B60D 1/48; B60D 1/54

(52) U.S. Cl. CPC B60R 19/34; B60D 1/06; B60D 1/485; B60D 1/54; B60D 2001/544

(57) ABSTRACT

In order to provide a rear impact unit, which is mounted or mountable on a vehicle rear in a manner hidden by a bumper unit, and which extends transversely to a vehicle longitudinal direction and transversely to a vehicle longitudinal center plane, and which where necessary gives the possibility of forming a transverse carrier unit for a trailer coupling, it is proposed that the rear impact unit should comprise two box structures, which are arranged at a spacing from one another, and a central carrier, which is arranged between these and connects them to one another, that as a result of fixing the box structures on the vehicle rear a transverse carrier unit comprising the central carrier and box structures should be mountable, and that the box structures should be supported against the vehicle rear by mounting elements that are mountable thereon and are deformable in the event of a crash.

### CROSS-REFERENCE TO RELATED PATENT APPLICATIONS

The present disclosure relates to the subject matter disclosed in German application number 10 2025 108 008.9 of 3 Mar. 2025 and German application number 10 2025 121 670.3 of 3 Jun. 2025, which are incorporated herein by reference in their entirety and for all purposes.

### BACKGROUND OF THE INVENTION

The invention relates to a rear impact unit, which is mounted or mountable on a vehicle rear in a manner hidden by a bumper unit, and which extends transversely to a vehicle longitudinal direction and transversely to a vehicle longitudinal center plane.

Rear impact units of this kind are known from the prior art.

In these, the problem arises that they are not suitable for serving where necessary as a transverse carrier unit for a trailer coupling.

In accordance with an embodiment of the invention, a rear impact unit is provided that where necessary gives the possibility of forming a transverse carrier unit for a trailer coupling.

### SUMMARY OF THE INVENTION

In accordance with an embodiment of the invention, in the case of a rear impact unit of the type mentioned in the introduction, provision is made that the rear impact unit comprises two box structures, which are arranged at a spacing from one another, and a central carrier, which is arranged between these and connects them to one another, that as a result of fixing the box structures on the vehicle rear a transverse carrier unit comprising the central carrier and box structures is mountable, and that the box structures are supported against the vehicle rear by mounting elements that are mountable thereon and are deformable in the event of a crash.

The advantage of the solution according to the invention can be seen in the fact that the rear impact unit is suitable for absorbing the energy of a crash and can thus be installed as standard in vehicles and if a trailer coupling is desired can be provided with a ball neck.

In this context, the transverse carrier unit is deformable in particular in the region of the box structures, but a variant in which the central carrier is suitable for absorbing a crash is also possible.

It is particularly favorable, in the solution according to the invention, if the central carrier is fixedly connected to the box structures, and in particular if forces acting on it are introduced into the box structures and where appropriate from these into the vehicle rear.

This can be achieved in a particularly favorable manner if the mounting element has a supporting face that is adapted to a mounting face of the vehicle rear, in order to act on the supporting face of the vehicle rear over as extensive an area as possible.

Further, it is preferably provided for the mounting element to have a plurality of cohesive support segments that form the supporting face and through which force is introduced into the mounting face.

For the purpose of optimal absorption of a crash, it is provided for each box structure to have an impact element which faces away from the mounting element and which, in the event of a rear crash, is able to absorb the forces acting on the box structure during impact.

In this case too, it is preferably provided for the respective impact element to be formed by cohesive impact segments in order on the one hand to contribute to a saving on the weight of the rear impact unit but on the other also to have sufficient stability to absorb the impact.

More detailed statements have not yet been made as regards the form taken by the box structures.

Thus, an advantageous solution provides for the box structures each to have strut structures which are arranged between the impact element and the mounting element and which are in particular able to absorb the impact energy as a result of deformation.

In this context, it is favorably provided for the box structures each to have at least two strut elements, which run at a spacing from one another between the impact element and the mounting element and which may serve to take up and absorb the impact energy at least in the event of a low-energy rear crash.

More detailed statements have not been made, in conjunction with the explanation of the invention so far, as regards the form taken by the strut elements.

Thus, an advantageous exemplary embodiment provides for one of the strut elements to face and to be connected to the central carrier.

In particular here, the at least one strut element takes a form such that it runs transversely to the direction of extent of the central carrier.

It is particularly advantageous if the box structures have at least two strut elements which are arranged at a spacing from one another and which run transversely to the direction of extent of the central carrier.

Moreover, for the purpose of optimal energy absorption, it is provided for the box structures to have at least one strut element that runs approximately parallel to the direction of extent of the central carrier.

In this context, for advantageous energy absorption, it is in particular provided for each of the box structures to have at least two strut elements which are arranged at a spacing from one another and which run approximately parallel to the direction of extent of the central carrier.

In order to protect the vehicle rear as much as possible, it is preferably provided for the mounting element to have a greater deformation resistance to plastic deformation than all the strut elements of the box structures.

In this context, the deformation resistance to plastic deformation results from the parameters relating to the geometry of the part and those relating to the flow limit or yield point of the material of this part.

In particular, it is provided for at least one of the strut elements that run transversely to the direction of extent of the central carrier to have a greater deformation resistance to plastic deformation than at least one of the strut elements that run approximately parallel to the direction of extent of the central carrier.

Further, for the purpose of optimal crash absorption, it is provided for at least one of the strut elements that run transversely to the direction of extent of the central carrier to have a greater deformation resistance to plastic deformation than at least one of the strut elements that run approximately parallel to the direction of extent of the central carrier.

Moreover, no statements have yet been made as regards the deformation resistance of the impact element.

In this context, it is preferably provided for the impact element to have a lower deformation resistance to plastic deformation than the mounting element.

Further, it is provided for the impact element to have a lower deformation resistance to plastic deformation than the at least one strut element that extends transversely to the direction of extent of the central carrier.

As a result, the box structure according to the invention allows absorption of the impact energy therein to be optimized.

For the purpose of saving on the weight of the rear impact unit, it has proved advantageous if at least one of the strut elements has strut segments extending around an aperture.

It is particularly favorable if each strut element has strut segments extending around an aperture.

Further, in this context, it is likewise provided for the mounting element to have planar support segments that extend around an aperture in order to obtain a saving on weight despite the large surface extent.

Moreover, it is preferably provided for the impact element to have planar impact segments that extend around an aperture in order likewise to obtain a saving on weight at the same time as a large surface extent.

As regards an optimal introduction of force from the central carrier to the mounting element, it has proved favorable if the strut element that carries the central carrier is connected in one piece with the mounting element.

In this context, it is in particular provided for the central carrier to be connected to the strut segments of the strut element carrying it with positive locking or by substance-to-substance bond, wherein the central carrier is in particular connected to all the strut segments with positive locking and/or by substance-to-substance bond, in order to achieve an optimal introduction of force.

In order to introduce the forces from the mounting elements into the vehicle rear while protecting it as much as possible, it is preferably provided for the mounting element to have a greater surface extent than the impact element.

In order, in particular in the event of an impact, to transfer the forces optimally to the mounting element and from there to the vehicle rear, it is provided for strut segments of the strut elements that extend between the impact element and the mounting element, in particular of the strut elements that extend transversely to the direction of extent of the central carrier, to be connected to regions of the mounting element in which there are located mounting points for fixing the respective mounting element to the vehicle rear.

In this context, it is in particular provided for the mounting element to be connected in one piece with at least one strut element, in particular a strut element that extends transversely to the direction of extent of the central carrier.

It is even more advantageous if the impact element is connected in one piece with at least one strut element.

Further, optimal crash absorption is achieved if the strut elements surround a cavity located between the impact element and the mounting element.

More detailed statements have not yet been made as regards the form taken by the central carrier.

Thus, a favorable solution provides for the central carrier to be a part that extends between the box structures and is similar to a tube or takes the form of a profile element, in particular without a specific crash-absorbing geometry.

In this case, the central carrier takes a form corresponding to a conventional transverse carrier unit, and only the box structures serve to take up the crash energy in the event of a rear crash.

Another advantageous solution provides for the central carrier to take the form of a box body and thus to be configured as particularly crash-absorbing.

In this case, the central carrier takes a form such that where necessary it is additionally able to absorb crash energy and in particular to transfer it optimally to the box bodies.

In this context, it is particularly advantageous if the central carrier has a wall element that faces away from the road surface and a wall element that faces the road surface, wherein these contribute in particular to the rigidity of the box body.

Preferably here, it is provided for the central carrier to have a wall element which faces away from the road surface and which extends between and is connected to the box structures.

Further, it is preferably provided for the central carrier to have a wall element which faces the road surface and which extends between and is connected to the box structures.

Moreover, for the purpose of stabilizing the box body, it is provided for the central carrier to have a wall element which faces away from the vehicle and which extends between and is connected to the box structures.

Moreover, it is preferably provided for the central carrier to have a wall element which faces the vehicle and which extends between and is in particular connected to the box structures.

In this context, the wall element that faces away from the vehicle and the one that faces the vehicle in particular serve to reinforce the wall elements facing or facing away from the road surface.

In this context, it is preferably provided for the wall element that faces away from the vehicle and the wall element that faces the vehicle to be connected to one another by a connection part located centrally between the box structures.

For manufacturing reasons it is advantageous if the wall element that faces away from the vehicle is formed from two wall element parts.

Similarly, from the point of view of manufacturing it is advantageous if the wall element that faces the vehicle is formed from two wall element parts.

As regards manufacturing options, it has proved particularly favorable if at least one wall element part that faces the vehicle and one wall element part opposite this that faces away from the vehicle are connected by a connection element which extends between them and reinforces these wall element parts relative to one another, at a spacing from the box structures.

It has proved particularly advantageous for the manufacturing options if the wall element part that faces the vehicle and the wall element part that faces away from the vehicle and the connection element are connected in one piece with one another.

Fundamentally, it would be sufficient if one wall element part facing the vehicle and one wall element part facing away from the vehicle were connected to one another by a connection part, while the other wall element part facing the vehicle and the other wall element part facing away from the vehicle were each connected to the associated wall element part as a separate part.

However, it has proved particularly favorable if both wall element parts facing the vehicle and the wall element parts facing away from the vehicle which respectively face these are in each case connected to one another by a connection part.

In this context, it is in particular advantageous if the connection parts abut against one another and are in particular connected to one another.

Fundamentally, the connection parts may serve only to reinforce the box body.

If there is provision to mount a trailer coupling, however, it has proved advantageous if the connection parts form a mounting flange for a trailer coupling.

In order further to achieve optimal reinforcement of the box body, it is provided for the wall element parts that face away from the vehicle and the wall element parts that face the vehicle to be connected to one another by a wall element facing away from the road surface and/or facing the road surface.

Another advantageous solution provides for a central wall element to be arranged between the wall elements that face the road surface and face away from the road surface, and the wall elements that face the vehicle and face away from the vehicle.

As regards optimal stability, as an alternative it is provided for at least one, in particular a plurality of reinforcement elements to run transversely between the wall element facing away from the road surface and the wall element facing the road surface.

In particular, the rigidity of the box body can be further improved if a central wall element is arranged between the wall elements that face the road surface and face away from the road surface, and the wall elements that face the vehicle and face away from the vehicle.

Further, it is preferably provided for at least one, in particular a plurality of reinforcement elements to run transversely to the wall elements that face away from the road surface and face the road surface, and the central wall element.

A further advantageous solution provides for at least one of the wall elements of the box body comprising the wall element facing away from the road surface and the wall element facing the road surface, and at least one of the wall elements of the box body comprising the wall element facing away from the vehicle and the wall element facing the vehicle, to be made from one sheet of material and connected in one piece with one another, at least in certain regions.

The advantage of this solution can be seen in the fact that, as a result, at least two of the wall elements are connected in one piece with one another, at least in certain regions, because they are made from one and the same sheet of material, and, as cohesive wall elements, are thus part of the box body.

It is particularly favorable if at least three of the wall elements are made from a single sheet of material and are connected in one piece with one another, at least in certain regions, with the result that three wall elements already form a single part for further processing.

More detailed statements have not yet been made as regards the form taken by the wall elements themselves.

Thus, it is for example conceivable for each of the wall elements to take the form of a single cohesive part.

A further advantageous solution provides for at least one of the wall elements to take a multi-part form and to have a central part and side parts, in order that these can easily be adapted to a desired shape of the box body.

The wall element taking a form of this kind has the advantage that the side parts can be oriented differently in relation to the central part.

For example, in this context it is provided for the side parts to be connected, in particular welded, to two mutually opposing wall elements, and in this way for the side parts not to need to be connected themselves in one piece with a further wall element.

A further advantageous solution provides for at least one of the central parts to be connected in one piece with at least one of the wall elements adjoining it.

It is particularly favorable if the at least one of the central parts is connected to two mutually opposing wall elements that adjoin it, such that the central part is located between these wall elements.

As regards the side parts, it is further provided for the side parts to run outside a plane predetermined by the central part, in order to improve the dimensional stability of the box body.

This means that the central part extends for example in one plane and the side parts each extend in a plane deviating from this plane.

In this context, it is for example provided for the side parts to be bent in relation to the central part, for example for the central part to merge into the side parts as a result of a bend line.

A further advantageous solution provides for the side parts to be connected in one piece with the at least one central part and thus still to form a single wall element with the at least one central part.

As an alternative, it is provided for at least one of the central parts to be connected to the side parts by positively locking elements, in order in this way to give the possibility of mounting the central part and the side parts on the box body independently of one another.

Moreover, it is favorably provided for at least one of the central parts to be connected to at least one of the adjoining wall elements by positively locking elements.

Preferably, the central part is connected to both wall elements adjoining it by positively locking elements.

This provides the possibility of mounting the central part independently of the side parts and thus for example opening up a mounting opening for mounting a pivotal unit on a mounting flange in the interior of the box body.

In particular in the case of the box body, it is provided for the wall element that faces away from the road surface and the wall element that faces the road surface to have a greater deformation resistance to plastic deformation than the wall element that faces away from the vehicle and the wall element that faces the vehicle.

Thus, the description above of solutions according to the invention comprises in particular the different combinations of features that are defined by the sequentially numbered embodiments below.
1. A rear impact unit (20), which is mounted or mountable on a vehicle rear (14) in a manner hidden by a bumper unit (16), and which extends transversely to a vehicle longitudinal direction (36) and transversely to a vehicle longitudinal center plane (18), wherein the rear impact unit (20) comprises two box structures (24, 26), which are arranged at a spacing from one another, and a central carrier (22), which is arranged between these and connects them to one another, in that as a result of fixing the box structures (24, 26) on the vehicle rear (14) a transverse carrier unit (30) comprising the central carrier (22) and box structures (24, 26) is mountable, and in that the box structures (24, 26) are supported against the vehicle rear (14) by mounting elements (32) that are mountable thereon and carry the transverse carrier unit (30), which is deformable in the event of a crash.
2. The rear impact unit (20) according to embodiment 1, wherein the central carrier (22) is fixedly connected to the box structures (24, 26), and in that in particular forces acting on it are introduced into the box structures (24, 26) and where appropriate from these into the vehicle rear (14).
3. The rear impact unit (20) according to one of the preceding embodiments, wherein the mounting element (32) has a supporting face (62) that is adapted to a mounting face (34) of the vehicle rear (14).
4. The rear impact unit (20) according to one of embodiments 1 to 3, wherein the mounting element (32) has a plurality of cohesive support segments (64, 66, 72, 74) that form the supporting face (62).
5. The rear impact unit (20) according to one of the preceding embodiments, wherein each box structure (24, 26) has an impact element (48) which faces away from the mounting element (32).
6. The rear impact unit (20) according to embodiment 5, wherein the respective impact element (48) is formed by cohesive impact segments (152, 154, 156, 158).
7. The rear impact unit (20) according to one of the preceding embodiments, wherein the box structures (24, 26) each have strut elements (44, 46, 54, 56) which are arranged between the impact element (48) and the mounting element (32).
8. The rear impact unit (20) according to embodiment 7, wherein the box structures (24, 26) each have at least two strut elements (44, 46), which run at a spacing from one another between the impact element (48) and the mounting element (32).
9. The rear impact unit (20) according to embodiment 7 or 8, wherein at least one of the strut elements (44) faces and is connected to the central carrier (22).
10. The rear impact unit (20) according to one of embodiments 7 to 9, wherein at least one of the strut elements (44, 46) runs transversely to the direction of extent (28) of the central carrier (22).
11. The rear impact unit (20) according to one of embodiments 7 to 10, wherein the box structures (24, 26) have at least two strut elements (44, 46) which are arranged at a spacing from one another and which run transversely to the direction of extent (28) of the central carrier (22).
12. The rear impact unit (20) according to one of the preceding embodiments, wherein the box structures (24, 26) have at least one strut element (54, 56) that runs approximately parallel to the direction of extent (28) of the central carrier (22).
13. The rear impact unit (20) according to embodiment 12, wherein each of the box structures (24, 26) has at least two strut elements (54, 56) which are arranged at a spacing from one another and which run approximately parallel to the direction of extent (28) of the central carrier (22).
14. The rear impact unit (20) according to one of the preceding embodiments, wherein the mounting element (32) has a greater deformation resistance to plastic deformation than all the strut elements (44, 46, 54, 56) of the box structures (24, 26).
15. The rear impact unit (20) according to embodiment 14, wherein at least one of the strut elements (44, 46) that run transversely to the direction of extent (28) of the central carrier (22) has a greater deformation resistance to plastic deformation than at least one of the strut elements (54, 56) that run approximately parallel to the direction of extent (28) of the central carrier (22).
16. The rear impact unit (20) according to embodiment 14 or 15, wherein at least one of the strut elements (44, 46) that run transversely to the direction of extent (28) of the central carrier (22) has a greater deformation resistance to plastic deformation than at least one of the strut elements (54, 56) that run approximately parallel to the direction of extent (28) of the central carrier.
17. The rear impact unit (20) according to one of the preceding embodiments, wherein the impact element (48) has a lower deformation resistance to plastic deformation than the mounting element (32).
18. The rear impact unit (20) according to one of the preceding embodiments, wherein the impact element (48) has a lower deformation resistance to plastic deformation than the at least one strut element (44) that extends transversely to the direction of extent (28) of the central carrier (22).
19. The rear impact unit (20) according to one of the preceding embodiments, wherein at least one of the strut elements (44, 46, 54, 56) has strut segments (110, 112, 114, 116) extending around an aperture (76).
20. The rear impact unit (20) according to embodiment 19, wherein each strut element (44, 46, 54, 56) has strut segments (92, 94, 96, 98, 122, 124, 126, 128, 132, 134, 136, 138) extending around an aperture (110, 112, 114, 116).
21. The rear impact unit (20) according to one of the preceding embodiments, wherein the mounting element (32) has planar support segments (64, 66, 72, 74) that extend around an aperture (76).
22. The rear impact unit (20) according to one of the preceding embodiments, wherein the impact element (48) has planar impact segments (152, 154, 156, 158) that extend around an aperture (162).
23. The rear impact unit (20) according to one of the preceding embodiments, wherein the strut element (44) that carries the central carrier (22) is connected in one piece with the mounting element (32).
24. The rear impact unit according to one of the preceding embodiments, wherein the central carrier (22) is connected to the strut segments (92, 96, 102, 104) of the strut element (44) carrying it with positive locking and/or by substance-to-substance bond.
25. The rear impact unit (20) according to one of the preceding embodiments, wherein the mounting element (32) has a greater surface extent than the impact element (48).
26. The rear impact unit (20) according to one of embodiments 7 to 25, wherein the strut segments (92, 94, 96, 98) of the strut elements (44, 46) that extend between the impact element (48) and the mounting element (32) are connected to regions of the mounting element (32) in which there are located mounting points (82, 84, 86, 88) for fixing the respective mounting element (32) to the vehicle rear (14).
27. The rear impact unit (20) according to one of embodiments 7 to 26, wherein the mounting element (32) is connected in one piece with at least one strut element (44, 46).
28. The rear impact unit (20) according to one of embodiments 7 to 27, wherein the impact element (48) is connected in one piece with at least one strut element (44, 46).
29. The rear impact unit (20) according to one of embodiments 7 to 28, wherein the strut elements (44, 46, 54, 56) surround a cavity (142) located between the impact element (48) and the mounting element (32).
30. The rear impact unit (20) according to one of the preceding embodiments, wherein the central carrier (22) is a part that extends between the box structures (24, 26) and is similar to a tube or takes the form of a profile element.
31. The rear impact unit (20) according to one of embodiments 1 to 30, wherein the central carrier (222) takes the form of a box body (224).
32. The rear impact unit (20) according to embodiment 31, wherein the central carrier (22) has a wall element (232) that faces away from the road surface and a wall element (234) that faces the road surface.
33. The rear impact unit (20) according to embodiment 31 or 32, wherein the central carrier (222) has a wall element (232) which faces away from the road surface and which extends between and is connected to the box structures (24, 26).
34. The rear impact unit (20) according to embodiment 31 to 33, wherein the central carrier (222) has a wall element (234) which faces the road surface and which extends between and is connected to the box structures (24, 26).
35. The rear impact unit (20) according to one of embodiments 31 to 34, wherein the central carrier (222) has a wall element (236) which faces away from the vehicle and which extends between the box structures (24, 26).
36. The rear impact unit (20) according to one of embodiments 31 to 35, wherein the central carrier (222) has a wall element (238) which faces the vehicle and which extends between the box structures (24, 26).
37. The rear impact unit (20) according to one of embodiments 31 to 36, wherein the wall element (236) that faces away from the vehicle and the wall element (238) that faces the vehicle are connected to one another by a connection part (246) located centrally between the box structures (24, 26).
38. The rear impact unit (20) according to one of embodiments 31 to 37, wherein the wall element (236) that faces away from the vehicle is formed from two wall element parts (354, 364).
39. The rear impact unit (20) according to one of embodiments 31 to 38, wherein the wall element (238) that faces the vehicle is formed from two wall element parts (356, 366).
40. The rear impact unit (20) according to one of embodiments 37 to 39, wherein at least one wall element part (356, 366) that faces the vehicle and one wall element part (354, 364) opposite this that faces away from the vehicle are connected by a connection element (358, 368) which extends between them and reinforces these wall element parts (354, 356, 364, 366) relative to one another, at a spacing from the box structures (24, 26).
41. The rear impact unit (20) according to embodiment 40, wherein the wall element part that faces the vehicle and the wall element part that faces away from the vehicle and the connection element (358, 368) are connected in one piece with one another.
42. The rear impact unit (20) according to embodiment 40 or 41, wherein both wall element parts (356, 366) facing the vehicle and the wall element parts (354, 356) facing away from the vehicle which respectively face these are in each case connected to one another by a connection part (358, 368).
43. The rear impact unit (20) according to embodiment 42, wherein the connection parts (358, 368) abut against one another.
44. The rear impact unit (20) according to embodiment 42 or 43, wherein the connection parts (358, 368) form a mounting flange (374) for a trailer coupling.
45. The rear impact unit (20) according to one of embodiments 31 to 44, wherein the wall element parts (354, 364) that face away from the vehicle and the wall element parts (356, 366) that face the vehicle are connected to one another by a wall element (232, 234) facing away from the road surface and/or facing the road surface.
46. The rear impact unit according to one of embodiments 31 to 45, wherein at least one, in particular a plurality of reinforcement elements (394, 396) runs transversely between the wall element (232) facing away from the road surface and the wall element (234) facing the road surface.
47. The rear impact unit (20) according to one of embodiments 31 to 46, wherein a central wall element (392) is arranged between the wall elements (232, 234) that face the road surface and face away from the road surface, and the wall elements (236, 238) that face the vehicle and face away from the vehicle.
48. The rear impact unit (20) according to embodiment 46 or 47, wherein at least one, in particular a plurality of reinforcement elements (394, 396) runs transversely to the wall elements (232, 234) that face away from the road surface and face the road surface, and the central wall element (392).
49. The rear impact unit according to one of embodiments 31 to 48, wherein at least one of the wall elements comprising the wall element (232) facing away from the road surface and the wall element (234) facing the road surface, and at least one of the wall elements comprising the wall element (236) facing away from the vehicle and the wall element (238) facing the vehicle, are made from one sheet of material and connected in one piece with one another, at least in certain regions.
50. The rear impact unit according to embodiment 49, wherein at least three of the wall elements (232″′, 234″′, 236″′, 238″′) are made from one sheet of material and are connected in one piece with one another, at least in certain regions.
51. The rear impact unit according to embodiment 49 or 50, wherein at least one of the wall elements (232″′, 234″′, 236″′, 238″′) takes a multi-part form and has a central part (402, 412) and side parts (404, 406, 414, 416).
52. The rear impact unit according to embodiment 51, wherein the side parts (404, 406, 414, 416) are fixedly connected, in particular welded, to two mutually opposing wall elements (232″′, 234″′).
53. The rear impact unit according to one of embodiments 51 or 52, wherein one of the central parts (402) is connected in one piece with at least one of the wall elements (232″′, 234″′) adjoining it.
54. The rear impact unit according to one of preceding embodiments 51 to 53, wherein the side parts (404, 406, 414, 416) run outside a plane predetermined by the central part (402, 412).
55. The rear impact unit according to embodiment 54, wherein the side parts (404, 406, 414, 416) are bent in relation to the central part (402, 412).
56. The rear impact unit according to one of embodiments 51 to 55, wherein the side parts (404, 406, 414, 416) are connected in one piece with one of the central parts (402, 412).
57. The rear impact unit according to one of embodiments 51 to 56, wherein at least one of the central parts (412) is connected to the side parts (414, 416) by positively locking elements (424).
58. The rear impact unit according to one of embodiments 51 to 56, wherein at least one of the central parts (412) is connected to at least one of the wall elements (232″′, 234″′) by positively locking elements (422).
59. The rear impact unit according to one of embodiments 31 to 58, wherein the wall element (232) that faces away from the road surface and the wall element (234) that faces the road surface have a greater deformation resistance to plastic deformation than the wall element (236) that faces away from the vehicle and the wall element (238) that faces the vehicle.

Further features and advantages of the solution according to the invention form the subject matter of the description below and the representation in the drawing of some exemplary embodiments.

### BRIEF DESCRIPTION OF THE DRAWINGS

FIG. 1 shows a side view of a vehicle body of a vehicle, with a bumper unit arranged on the vehicle rear;

FIG. 2 shows a rear view of the vehicle body, with the bumper unit arranged on the vehicle rear and covering a rear impact unit;

FIG. 3 shows an illustration of a first exemplary embodiment of a rear impact unit according to the invention;

FIG. 4 shows an enlarged illustration of the box structure, according to B in FIG. 3;

FIG. 5 shows a view of FIG. 4, seen in the direction of the arrow C in FIG. 4;

FIG. 6 shows an illustration similar to FIG. 4, of a second exemplary embodiment of the box structure, according to the first exemplary embodiment of the rear impact unit according to the invention;

FIG. 7 shows a view similar to FIG. 3, of a third exemplary embodiment of the box structures for the first exemplary embodiment of the rear impact unit according to the invention;

FIG. 8 shows a view of the third exemplary embodiment of the box structure, similar to FIG. 4;

FIG. 9 shows a fourth exemplary embodiment of the box structure, according to FIG. 4;

FIG. 10 shows a fifth exemplary embodiment of the box structure, according to FIG. 4 of the first exemplary embodiment of the rear impact unit according to the invention;

FIG. 11 shows a sixth exemplary embodiment of the box structure, according to FIG. 4;

FIG. 12 shows a seventh exemplary embodiment of the box structure, similar to FIG. 4 and FIG. 6;

FIG. 13 shows a first variant of the rear impact unit according to FIG. 3, with a receiving body comprising a receptacle for an insertion portion of a coupling element or a load carrier;

FIG. 14 shows a second variant of the rear impact unit according to FIG. 3, with a pivotal unit mounted on the central carrier, for a pivotal ball neck for forming a trailer coupling;

FIG. 15 shows an illustration of the second variant of the rear impact unit taking the form of a trailer coupling, seen in the direction of the arrow E, that is say as seen from the vehicle rear;

FIG. 16 shows an illustration of a third variant of the rear impact unit according to the invention, with a box body;

FIG. 17 shows an exploded illustration of the box body according to FIG. 16;

FIG. 18 shows a fourth variant of a rear impact unit according to the invention, with a pivotal unit for pivotal mounting of a ball neck;

FIG. 19 shows an illustration of a fifth variant of the rear impact unit according to the invention;

FIG. 20 shows an exploded illustration of the box body of the fifth variant of the rear impact unit, according to FIG. 19;

FIG. 21 shows an illustration of the box body that is provided with a pivotal unit for a pivotal ball neck, of the fifth variant according to FIGS. 19 and 20, for forming a trailer coupling;

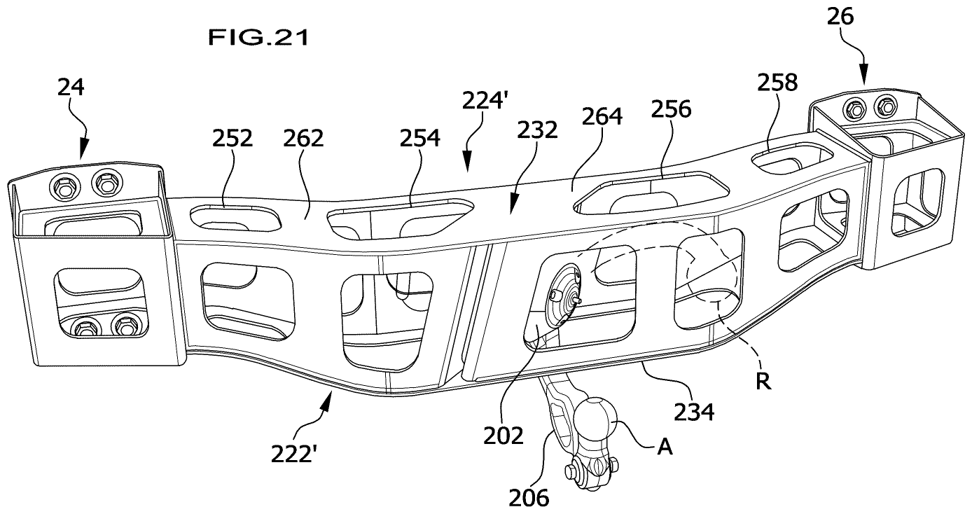

FIG. 22 shows a sixth variant of a rear impact unit according to the invention, with a variant of the box body, provided with a receiving body for receiving an insertion portion of a coupling element for a trailer or a load carrier, but without illustrating a wall element that faces away from the vehicle;

FIG. 23 shows a complete illustration of the box body of the sixth variant of the rear impact unit, with an insertion portion of a coupling element for a trailer inserted into the receiving body;

FIG. 24 shows a seventh variant of a rear impact unit according to the invention, with a further variant of the box body;

FIG. 25 shows an exploded illustration of the central carrier of the seventh variant, according to FIG. 24;

FIG. 26 shows a perspective illustration of the seventh variant of the rear impact unit, according to FIG. 24, provided with a receiving body for receiving an insertion portion of a coupling element for a trailer or a load carrier;

FIG. 27 shows a perspective illustration of the seventh variant of the rear impact unit, according to FIG. 24, provided with a pivotal unit for a pivotal ball neck;

FIG. 28 shows an exploded illustration of the box body of the seventh variant, according to FIG. 24, with a mounting flange for the pivotal unit;

FIG. 29 shows an eighth variant of a rear impact unit according to the invention, according to FIG. 24, with a box body having a multi-part wall element that faces the vehicle; and

FIG. 30 shows an exploded illustration of the eighth variant of the rear impact unit, according to FIG. 29, with the central part of the wall element that faces the vehicle not yet mounted.

### DETAILED DESCRIPTION OF THE INVENTION

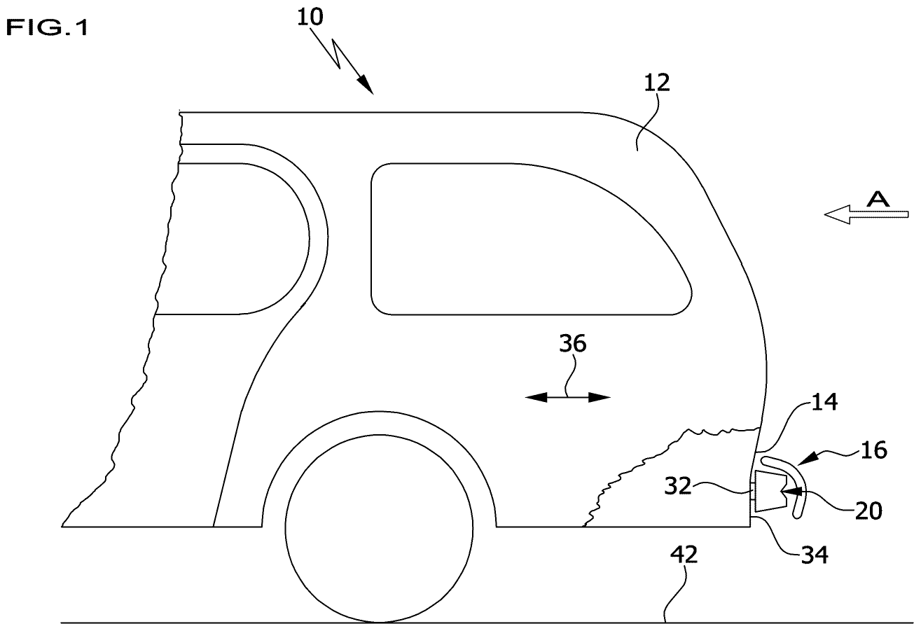

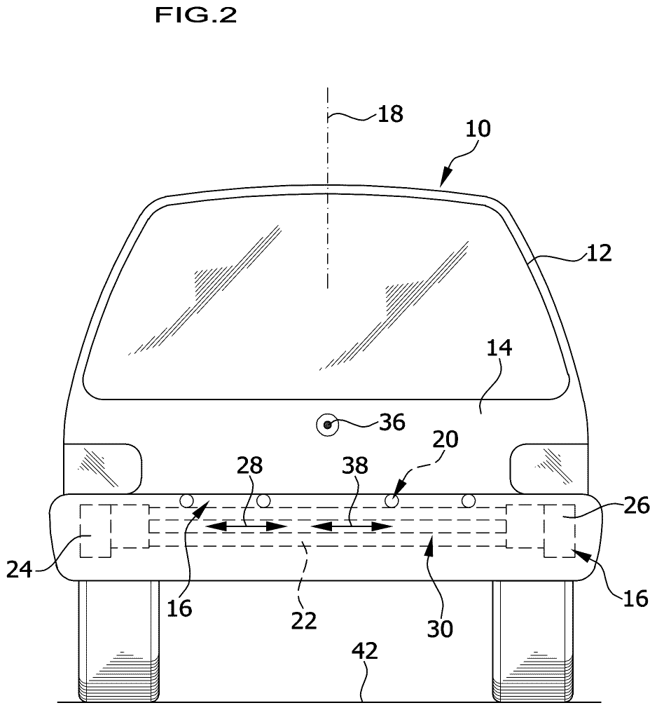

FIGS. 1 and 2 show a vehicle 10, of which the vehicle body 12 is provided at the vehicle rear 14 with a bumper unit 16 that runs transversely to a vehicle longitudinal center plane 18.

Hidden by the bumper unit 16 and provided on the vehicle rear 14 is a rear impact unit, designated 20 as a whole, which serves to absorb impact energy in the event of a rear impact.

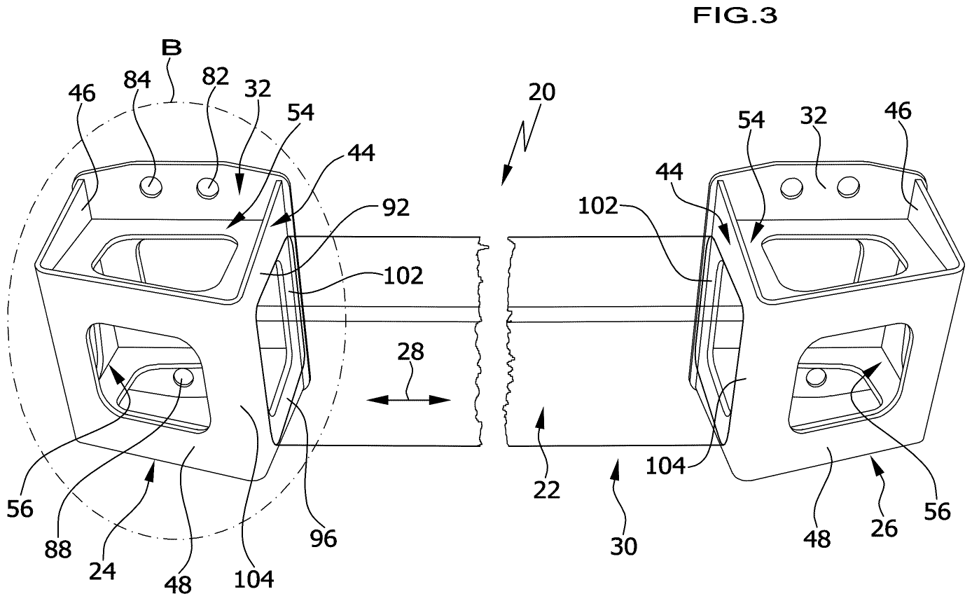

The rear impact unit 20 comprises a central carrier 22 (FIGS. 2 and 3), which takes the form in particular of a tubular body or indeed a profile shaped into an L or U shape or a C shape in cross section and which is arranged between two box structures 24 and 26 that on one side are connected to and carry the central carrier 22, and at another are each connected to a respective mounting element 32 which, for its part, is mountable and supported on a mounting face 34 provided on the vehicle rear 14 (FIG. 1).

The central carrier 22 is fixedly connected to the box structures 24 and 26 that are arranged on either side, forming a transverse carrier unit 30, and is supported by way of the box structures 24, 26 on the mounting faces 34 of the vehicle rear 14.

In this arrangement, the central carrier 22 then runs with its direction of extent 28 as a whole transverse to a vehicle longitudinal direction 36, in particular transverse to the vehicle longitudinal center plane 18, in a vehicle transverse direction 38 that runs approximately parallel to a road surface 42 on which the vehicle 10 stands.

A first such exemplary embodiment of a rear impact unit 20 according to the invention, illustrated in FIG. 3, has box structures 24 and 26 that are identical but formed in mirror image to one another, of which each has, extending from the mounting element 32, a strut structure 44 which lies on the inner side and to which the central carrier 22 is fixedly connected, and which extends away from the vehicle rear 14, transversely to the mounting element 32.

Moreover, each of the box structures 24 and 26 has a strut structure 46 that lies on the outer side and likewise extends away from the vehicle rear 14 from the mounting element 32, approximately parallel to the inner strut structure 44 but at a spacing therefrom.

Here, both strut structures 44 and 46 are fixedly connected to the mounting element 32, for example by weld connections.

At their end regions facing away from the mounting element 32, the two strut structures 44 and 46 merge into an impact element 48, which runs at a spacing from the vehicle rear 14 and at a spacing from the mounting element 32, and at which an impact of a vehicle striking against the rear of the vehicle 10 in the event of a crash takes place.

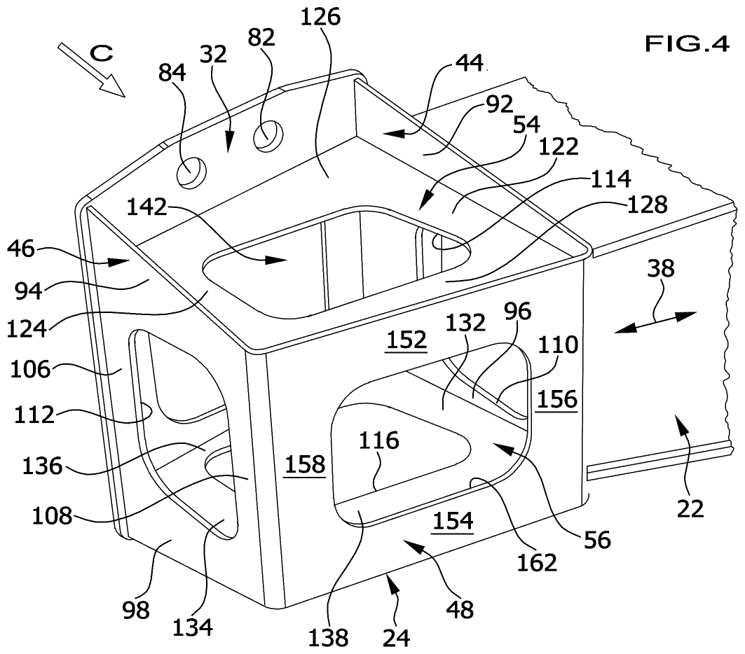

In the exemplary embodiment illustrated in FIGS. 3 and 4, the inner strut structure 44 and the outer strut structure 46 are connected in one piece with the impact element 48 and form an approximately U-shaped part, wherein for example the strut structure 44 extends further from the mounting element 32 than the strut structure 46, such that the impact element 48 does not run parallel to the mounting element 32 but along a plane at an angle in relation thereto.

In order to stabilize the strut structures 44 and 46 in the event of a crash acting on the impact element 48, each of the box structures 24 and 26 further comprises two reinforcing strut structures 54 and 56, which extend transversely to the strut structures 44 and 46 and to the impact element 48 and the mounting element 32, preferably approximately parallel to the vehicle transverse direction 38.

By contrast, the strut structures 44 and 46 preferably run transversely to the vehicle transverse direction 38 and approximately parallel to the vehicle longitudinal center plane 18, in particular at an angle of ±20° or less thereto.

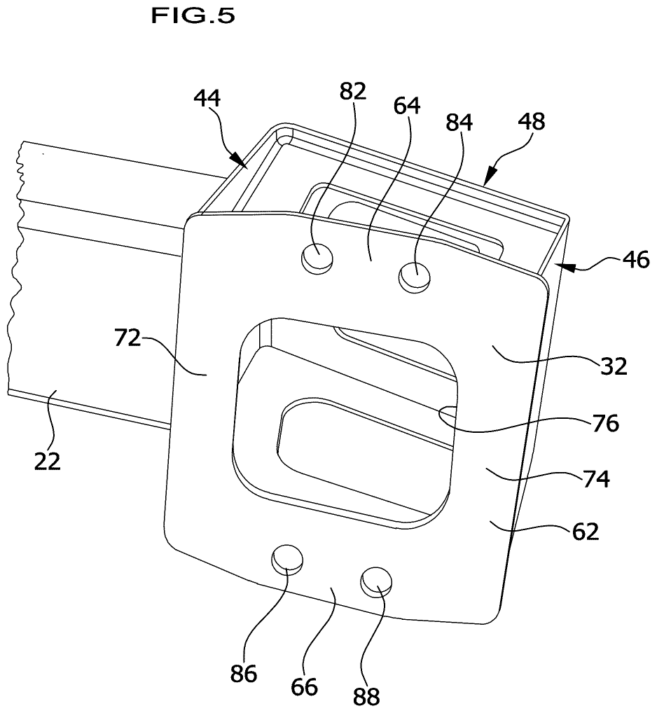

As illustrated in FIG. 5, the mounting element 32 is provided with a supporting face 62, of which the shape is adapted to the shape of the mounting face 34 of the vehicle rear 14.

In this arrangement, the supporting face 62 is formed by an upper (as seen in the vertical direction) support segment 64, a lower support segment 66, and lateral support segments 72 and 74 that extend between the support segments 64 and 66, wherein all the support segments 64, 66, 72, 74 merge into one another and are arranged to surround an in particular central aperture 76 in the mounting element 32.

Further, the upper support segment 64 has two mounting points 82 and 84, which are arranged at a spacing from one another, and the lower support segment 66 has two mounting points 86 and 88, which are arranged at a spacing from one another, in the region of which screws are applied, by which a connection with the vehicle rear 14 is made.

For the purpose of optimal force transfer from the strut structures 44 and 46 to the mounting element 32, the strut structures 44 and 46 take a form such that the mounting points 82 and 84, and 86 and 88, of the mounting element 32 are arranged between them, and in particular are not arranged respectively above or below upper or lower edges of the strut structures 44 and 46.

In particular, each of the strut structures 44 and 46 comprises respectively, in relation to the vertical direction, an upper strut segment 92 or 94 and a lower strut segment 96 or 98, which are connected to the mounting element 32 such that the upper mounting points 82 and 84 are located between the upper strut segments 92 and 94 and the lower mounting points 86 and 88 are located between the strut segments 96 and 98.

Further, as illustrated in FIG. 4, the upper mounting points 82 and 84 are located, in relation to the vertical direction, above the upper reinforcing strut structure 54, and the lower mounting points 86 and 88 are located below the lower reinforcing strut structure 56.

In addition, the strut structures 44 and 46 undergo a further reinforcement as a result of strut segments 102 and 104, and 106 and 108, respectively, which approximately connect into the upper strut segments 92 and 94 and the lower strut segments 96 and 98, wherein the strut segments 102 and 106 adjoin the mounting element 32 and are in particular connected thereto, whereas the strut segments 104 and 108 adjoin the impact element 48.

All the strut segments 92, 96, 102, 104 and 94, 98, 106 and 108 merge into one another in the respective strut structure 44 or 46, and surround an in particular central aperture 110, 112 which contributes to saving on weight.

Moreover, each of the reinforcing strut structures 54 and 56 comprises an in particular central aperture 114 and 116 respectively and strut segments that are arranged to surround this, wherein strut segments 122 and 124 of the reinforcing strut structure 54 adjoin the strut structures 44 and 46 and are rigidly connected thereto, whereas strut segments 126 and 128 of the reinforcing strut structure 54 adjoin the mounting element 32 and the impact element 48 respectively and are fixedly connected thereto (FIG. 4).

Similarly, the reinforcing strut structure 56 comprises strut segments 132 and 134, which adjoin the strut structures 44 and 46 and are fixedly connected thereto, for example by welding, and strut segments 136 and 138, which adjoin the mounting element 32 and the impact element 48 respectively and are fixedly connected thereto.

Overall, the respective box structure 24, 26 with the strut structures 44 and 46 and 54 and 56, respectively, in each case surrounds a central cavity 142, which is likewise located between the mounting element 32 and the impact element 48, and opens up the possibility that in the event of a crash the respective box structure 24, 26 can be deformed, wherein the respective strut segments 92 to 98, 102 to 108, 122 to 128 and 132 to 138 open up the possibility of adapting the respectively local rigidity to the demands of a crash, as a result of their surface extent.

In particular, in the case of the box structures 24 and 26, the deformation resistance to plastic deformation in the region of the reinforcing strut structures 54 and 56 is lower than in the region of the inner and outer strut structures 44 and 46, in order to achieve a vertical stability of the box structures 24, 26 that can take up an impact at different vertical levels above the road surface 42 and permit deformation in the direction of the mounting element 32 as a result of deformation of the reinforcing strut structures 54 and 56.

The deformation resistance to crash-related plastic deformation results from the geometry of the part and the parameters relating to the flow limit or yield point of the material of this part.

Moreover, because the inner strut structures 44 hold the central carrier 22, sufficient deformation resistance to plastic deformation in the region of these is likewise advantageous.

Moreover, the respective mounting element 32 is formed such that it has the greatest deformation resistance to plastic deformation, in order to transfer the forces occurring in the event of a crash to the mounting face 34 of the vehicle rear 14 over the largest possible surface area.

Further, in the first exemplary embodiment the respective impact element 48 is made from a material having the same deformation resistance to plastic deformation as the inner strut structure 44 and the outer strut structure 46, since the impact element 48 is integrally formed in one piece with the inner and outer strut structure 44, 46.

Moreover, however, the impact element 48 is also provided with impact segments 152 and 154, and 156 and 158, which surround an aperture 162 and merge into one another.

The rigidity of the individual impact segments 152 to 158 is establishable in this manner and also as a result of the form taken by the impact segments 152, 154, 156, 158 and the size of the aperture 162.

Preferably, the impact element 48 is formed such that it has a vertical extent of more than 100 mm, better more than 120 mm and preferably more than 150 mm, in order to be able optimally to absorb rear crashes that occur at different heights, depending on the different vehicle types.

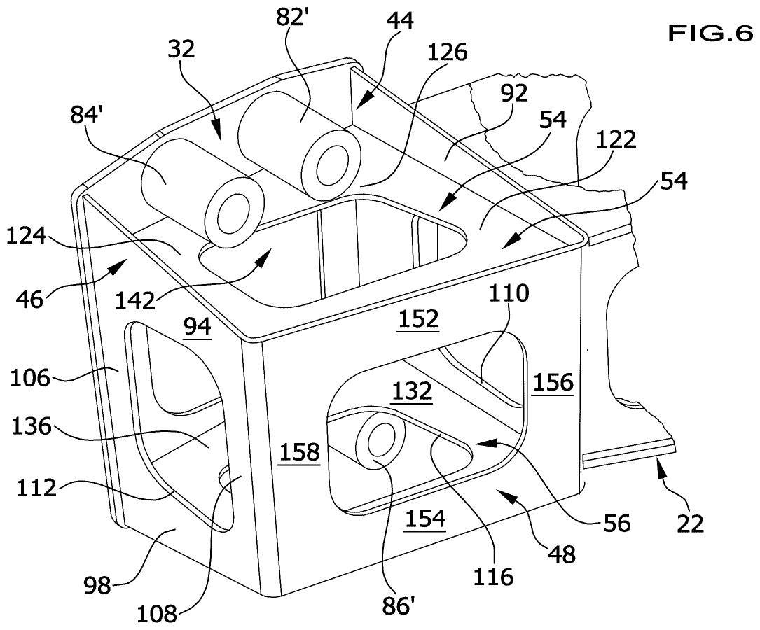

In a second exemplary embodiment of a rear impact unit 20 according to the invention, illustrated in FIG. 6, the elements that are identical to those in the first exemplary embodiment are provided with the same reference numerals, with the result that, for a description of these, reference is made to the statements relating to the first exemplary embodiment in their entirety.

In contrast to the first exemplary embodiment, the mounting points 82′, 84′, 86′, 88′ in the mounting element 32 do not take the form of apertures but are provided with cylindrical bodies extending away from the mounting element 32 in the direction of the strut structure 48, and these make it possible to use for example relatively long connection elements such as screws, which have greater elasticity than short screws and thus have less likelihood of breaking in the event of a crash.

Otherwise, as regards the other features of both the mounting element 32 and also the strut structures 44 and 46 and strut structures 54 and 56, reference is made to the statements relating to the first exemplary embodiment in their entirety.

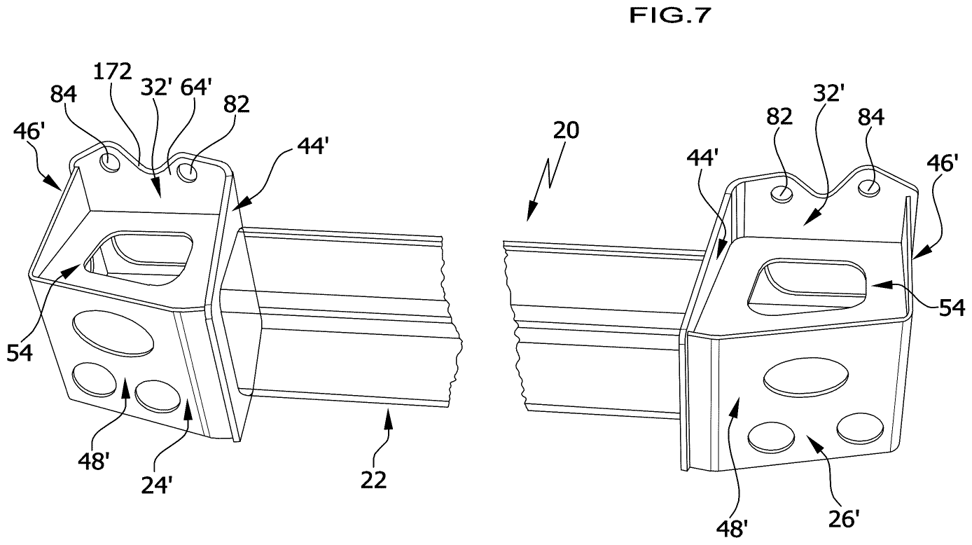

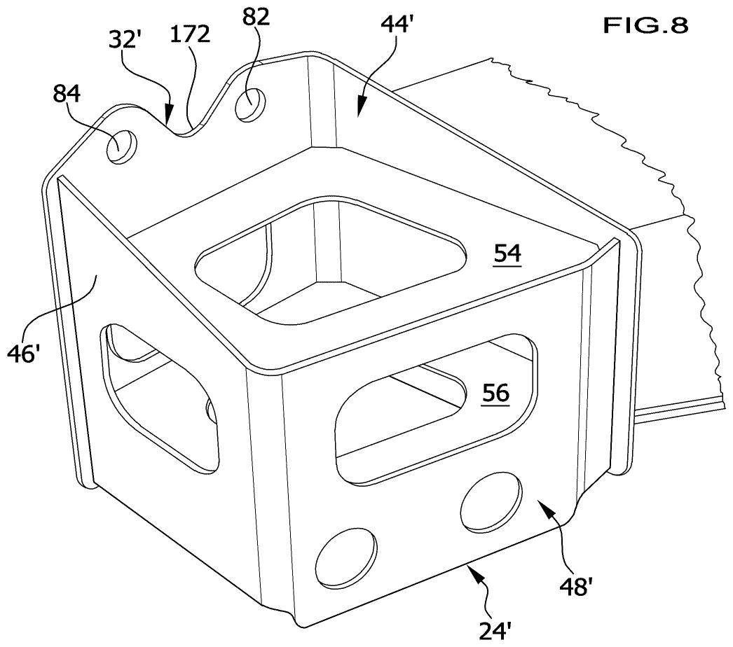

In a third exemplary embodiment of a rear impact unit 20 according to the invention, illustrated in FIGS. 7 and 8, the mounting element 32′ of the box structures 24′, 26′ is modified by comparison with the first exemplary embodiment in that the mounting element 32′ has a notch between the mounting points 82 and 84, in order to ensure optimal abutment of the mounting element 32′ against the mounting face 34.

Moreover, in this exemplary embodiment the inner strut structure 44′ is integrally formed in one piece with the mounting element 32 and thus has the same deformation resistance to plastic deformation, resulting from the thickness and rigidity of the material, as the mounting element 32′, which is of particular advantage if the central carrier 22 is to be suitable for heavy loads.

In this exemplary embodiment, moreover, the outer strut structure 46′ is also made from a material having a lower deformation resistance to plastic deformation than the material for the inner strut structure 44′, and the outer strut structure 46′ is further formed in one piece with the impact element 48′, which is thus likewise made from the same material as the outer strut structure 46′ and forms an L-shaped element therewith.

The use of the two L-shaped elements, namely the mounting element 32′ and the inner strut structure 44′ on the one hand and the outer strut structure 46′ and the impact element 48′ on the other, thus makes it possible on the one hand to simplify manufacture and on the other to achieve greater freedom in respect of planned possibilities for deformation of the box structures 24′ and 26′.

Otherwise, as regards the further features, reference is made to the first exemplary embodiment in its entirety.

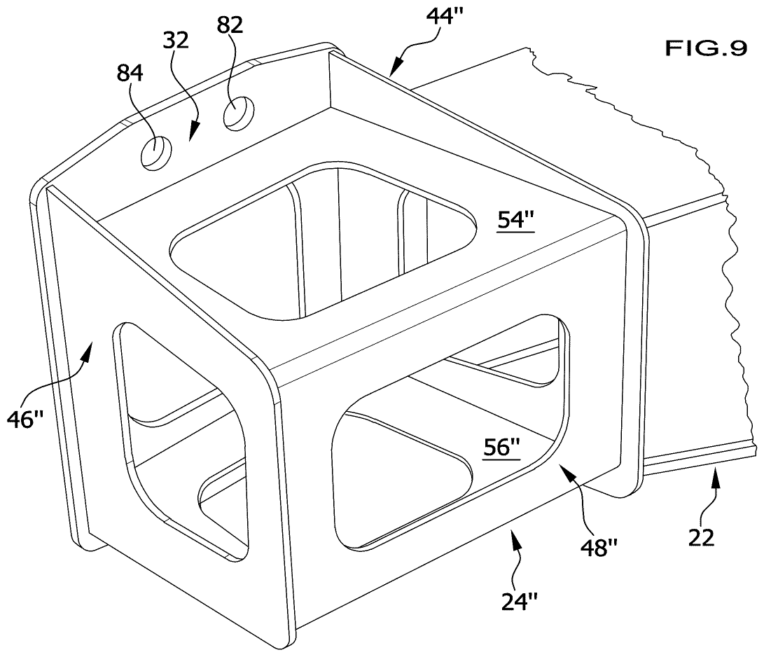

In a fourth exemplary embodiment, illustrated in FIG. 9, the mounting element 32 takes the same form as in the first exemplary embodiment, and moreover the inner strut structure 44″ and the outer strut structure 46″ are formed in the same way as in the first exemplary embodiment, but as strut structures held separately against the mounting element 32.

However, the impact element 48″ and the reinforcing strut structures 54″ and 56″ together form a U-shaped part that extends between the inner strut structure 44″ and the outer strut structure 46″ and is firmly connected thereto.

Here, in this exemplary embodiment, the impact element 48″ is made from the same material as the reinforcing strut structures 54″ and 56″ and thus from a thinner material, less structurally rigid and thus less resistant to deformation, than the inner strut structure 44″ and the outer strut structure 46″.

Otherwise, the strut structures 44, 46, 54, 56 are formed in the same way as in the first exemplary embodiment from strut segments 92 to 98, 102 to 106, 122 to 128 and 132 to 138, with the result that in this regard reference may be made to the first exemplary embodiment in its entirety.

Reference may also be made to the first exemplary embodiment as regards the form taken by the mounting element 32, wherein in this case the mounting element 32 is made from a material having the greatest deformation resistance to plastic deformation and the greatest thickness, while the inner strut structure 44 and the outer strut structure 46 are made from material having lower deformation resistance to plastic deformation and thickness than the mounting element 32.

Further, the impact element 48″ and the strut structures 54″ and 56″ are made of material of the same deformation resistance to plastic deformation and the same thickness, which are lower than those of the strut structures 44 and 46.

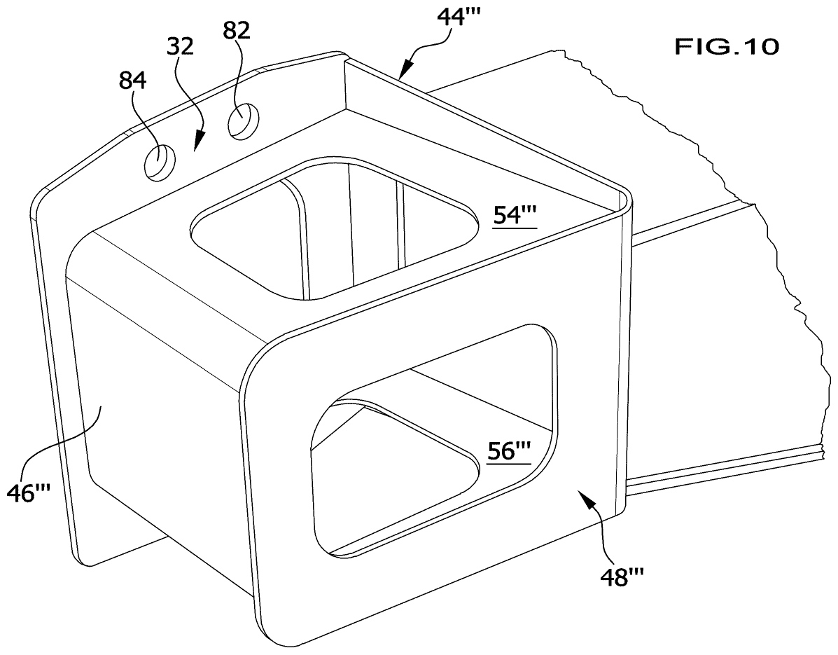

In a fifth exemplary embodiment, illustrated in FIG. 10, the inner strut structure 44″′ and the impact element 48″′ are made in one piece, from the same material having the same deformation resistance to plastic deformation, while the outer strut structure 46″′ and the reinforcing strut structures 54″′ and 56″′, for their part, are made from the same material, which has a lower deformation resistance to plastic deformation than the inner strut structure 44.

In this solution, in particular the mounting element 32 is the element having the greatest deformation resistance to plastic deformation.

Otherwise, as regards the inner strut structure 44″′ and the impact element 48″′ and the mounting element 32, reference is made to the first exemplary embodiment in its entirety.

In contrast to this, however, the outer strut structure 46″′ takes an unpierced form in order to compensate for the lower deformation resistance to plastic deformation of the material as a result of the unpierced configuration.

Otherwise, the reinforcing strut structures 54″′ and 56″′ take the same form as in the first exemplary embodiment, except that they are formed in one piece with the outer strut structure 46″′ into a U-shaped part.

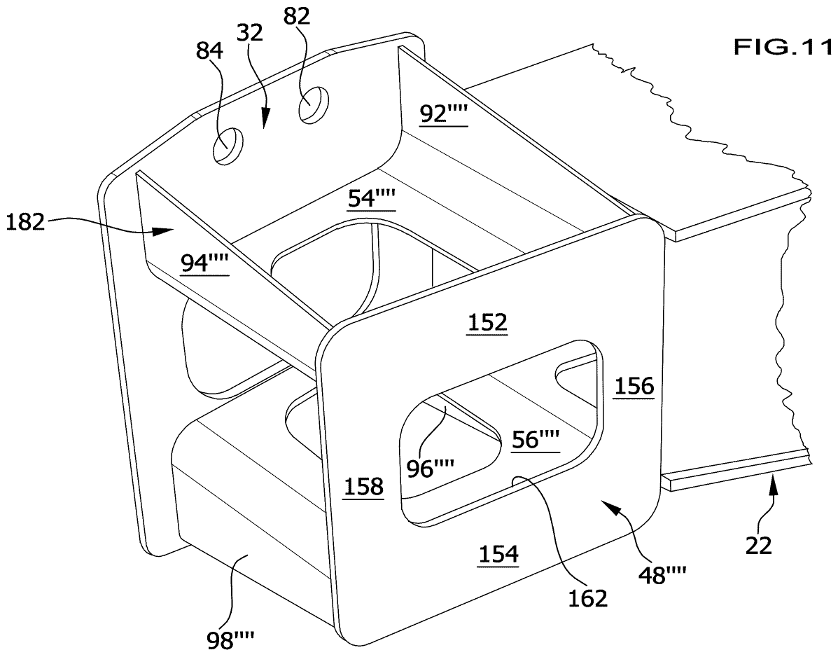

In a sixth exemplary embodiment, illustrated in FIG. 11, the mounting element 32 takes the same form as in the first exemplary embodiment, with the result that reference may be made to the statements relating to the first exemplary embodiment in their entirety.

Similarly, as regards its shape and its impact segments 152 to 158 and the aperture 162, the impact element 48″″ takes the same form as in the first exemplary embodiment, except that the impact element 48″″ is a separate part.

The impact element 48″″ and the mounting element 32 are connected by way of an upper U-shaped element 182 which comprises the strut structure 54″″ and, to either side, upper strut segments 92″″ and 94″″ that are integrally formed therewith and, together with the reinforcing strut structure 54″″, form a unit and are made from the same material with the same deformation resistance to plastic deformation.

Moreover, the reinforcing strut structure 56″″ likewise forms, together with the lower strut segments 96″″ and 98″″, a U-shaped part, with the result that the lower strut segments 96″″ and 98″″, together with the lower reinforcing strut structure 56″″, are also made to have the same deformation resistance to plastic deformation.

However, in this sixth exemplary embodiment, the strut segments 102 and 104, and 106 and 108, which are described in connection with the first exemplary embodiment, and which in the first exemplary embodiment connect the strut segments 94 and 98 to one another, are omitted.

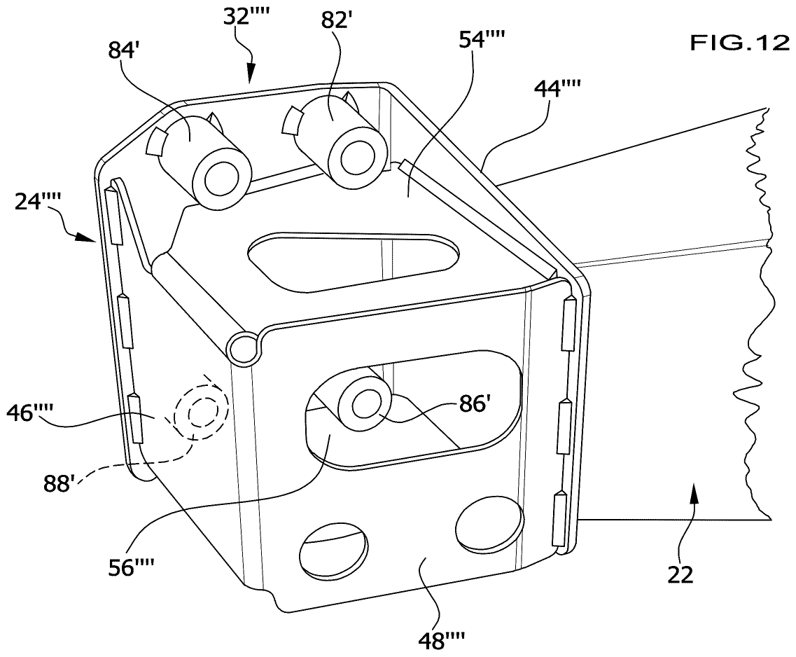

In a seventh exemplary embodiment, illustrated in FIG. 12, the mounting element 32 takes the same form as in the second exemplary embodiment, wherein the mounting points 84′, 82′, 86′ and 88′ are provided with cylindrical bodies which make it possible to use for example relatively long connection elements such as screws, which thus have greater elasticity.

Moreover, in the seventh exemplary embodiment according to FIG. 12 it is provided, in the same way as in the third exemplary embodiment according to FIGS. 7 and 8, for the outer strut structure 46″″ in the box structures 24″ (and 26″) to be formed in one piece with the impact element 48″″ but in addition also with the strut structures 54″″ and 56″″, which are then welded on the one hand to the inner strut structure 44″″ and on the other to the mounting element 32″″, which are connected in one piece with one another, with the result that the respective box structure 24″″ and the similarly configured box structure 26″″ can be formed from only two one-piece parts by being shaped and welded.

Preferably, in this case the strut structures 46″″, 48″″, 54″″ and 56″″ have the same deformation resistances to plastic deformation, as a result of being formed in one piece from the same material, wherein the deformation resistance to plastic deformation is lower in this case than the deformation resistance to plastic deformation of the inner strut structure 44″″ and the mounting element 32″″, both of which are likewise made from the same material with the same deformation resistance.

As regards further details, reference is made to the statements relating to the foregoing exemplary embodiments in their entirety.

The common feature of all seven of the exemplary embodiments described above of the rear impact units 20 according to the invention is that they represent a rear impact unit 20 which, as described, can be mounted on the vehicle rear 14 in a manner hidden by the bumper unit 16, and can protect the vehicle rear 14 from damage, at least in the case of a low-energy rear impact, wherein the impact energy during a rear impact of this kind acts either directly on the box structures 24 and 26 or on the central carrier 22, which, however, transfers this energy to the box structures 24, 26 and results in deformation of these.

A rear impact unit 20 of this kind also serves in particular to protect against a lateral rear impact, which as far as possible acts directly on one of the box structures 24 or 26.

However, a rear impact unit 20 of this kind is also flexibly shapeable than on the central carrier 22, where appropriate by the additional mounting or replacement thereof a device for attaching a trailer and/or for mounting a load carrier can be provided.

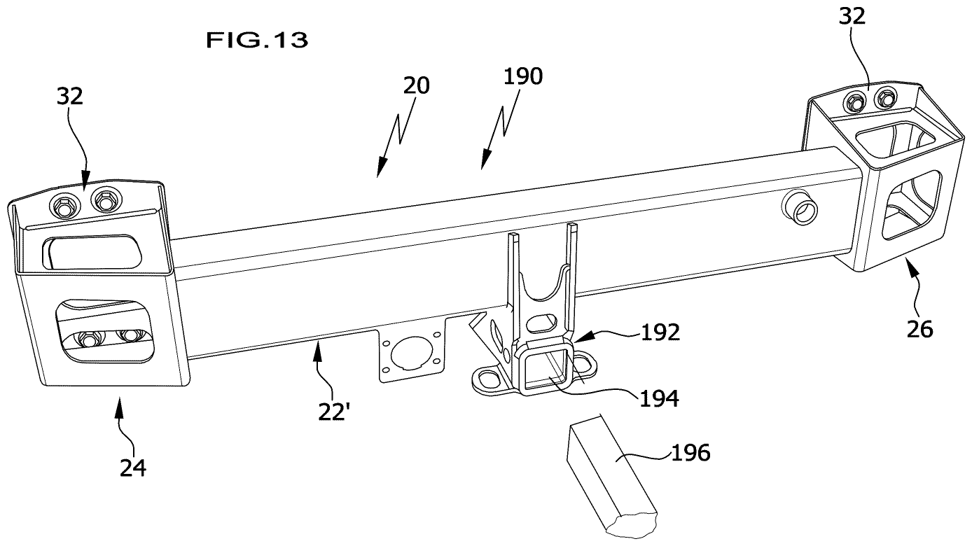

This is illustrated in FIG. 13 in the case of a variant 190 of this rear impact unit 20, based on the first exemplary embodiment or one of the further exemplary embodiments of the rear impact unit 20 according to the invention. Here, the central carrier 22′ is modified in that it has a receiving body 192 with a receptacle 194 for an insertion portion 196 of a coupling element for a trailer or load carrier, wherein the receptacle 194 is either fixedly connected to the central carrier 22′ or is movable in relation to the central carrier 22′.

Such receiving bodies 192 and receptacles 194 for insertion portions 196 of coupling elements or load carriers are described in full for example in the following patent applications: DE 10 2016 107 302; DE 10 2017 109 488; DE 10 2020 114 230; DE 10 2020 114 231; DE 10 2024 106 825; DE 10 2023 103 438; DE 10 2024 111 707; DE 10 2024 131 695; DE 10 2024 123 334; DE 10 2024 123 333.

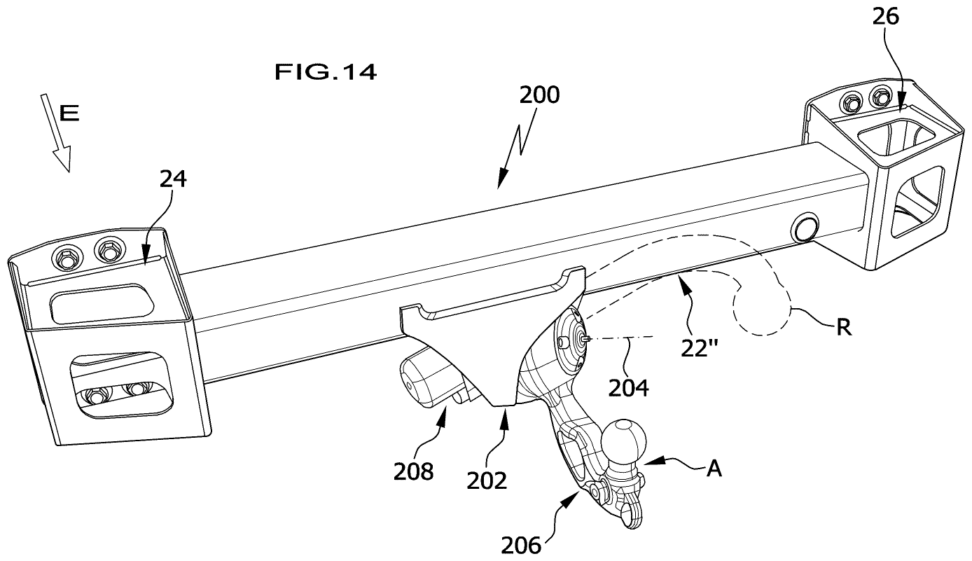

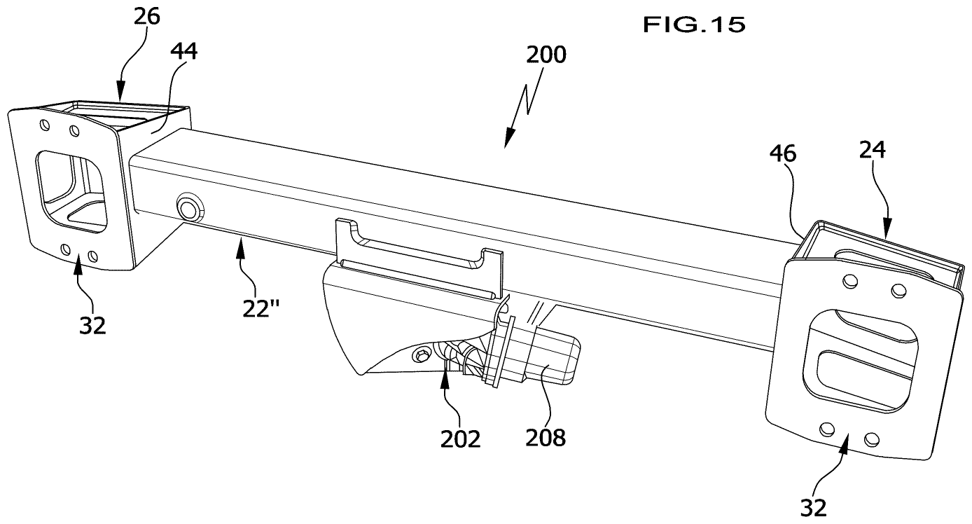

In a second variant 200 of the rear impact unit 20, based for example on the first exemplary embodiment of the rear impact unit 20 according to the invention, the central carrier 22″ is modified in that there is arranged thereon a pivotal unit 202 by which a ball neck 206 is mounted to pivot about a pivot axis 204 of the pivotal unit such that this ball neck 206 is pivotal about the pivot axis 204, from a working position A into a rest position R (illustrated in dashed lines in FIG. 14) in which the ball neck extends substantially along the central carrier 22″ of the variant of the rear impact unit 200 (FIGS. 14, 15).

In this context, the pivotal unit 202 preferably also has a drive unit 208 which is configured at least to actuate locking of the pivotal movement of the ball neck 206 about the pivot axis 205, or in addition to this also preferably to drive the pivotal movement.

Further, in this variant 200 of the rear impact unit, the central carrier 22″ is mountable on the vehicle rear 14 in the same way by the box structures 24, 26, wherein the box structures 24 and 26 for example take a form according to the first or further exemplary embodiments of the rear impact unit 20, so that in this regard reference may be made to the statements relating to the box structures of the foregoing exemplary embodiments.

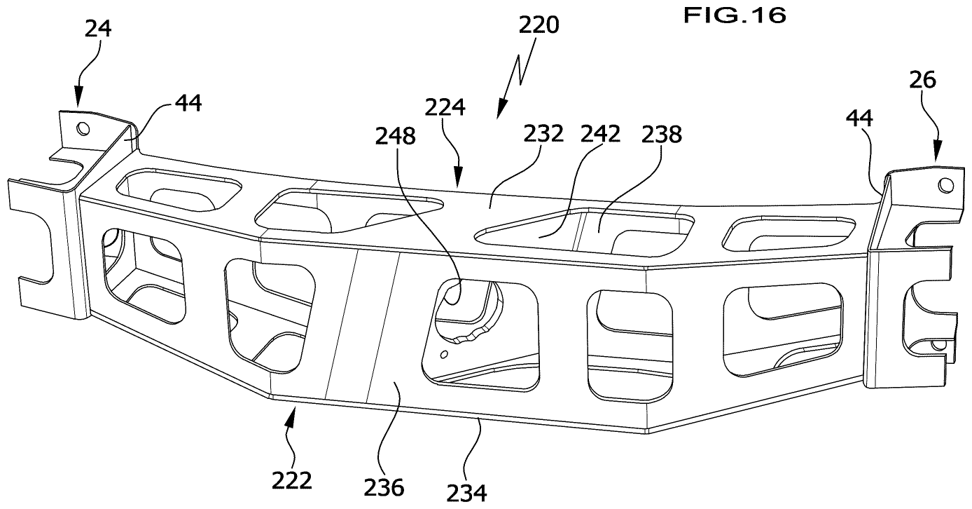

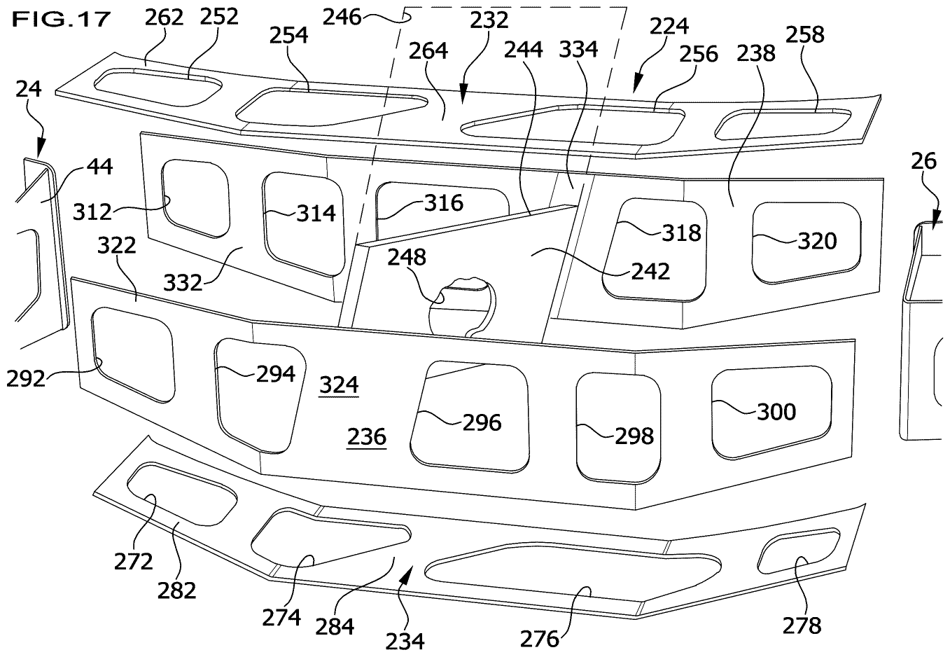

In a third variant 220 of the rear impact unit 20 according to the invention, illustrated in FIGS. 16 and 17, the central carrier 222 differs from the central carrier 22 according to the first exemplary embodiment in that it does not take the form of a tubular body but a box body 224 that extends between the box structures 24 and 26.

In this context, the box body 224 comprises a wall element 232 that faces away from the road surface and a wall element 234 that faces the road surface, which extend between the strut structures 44 of the box structures 24 and 26 and are fixedly connected thereto.

Here, the wall elements 232 and 234 run in the vertical direction in relation to the road surface, at a spacing from one another.

Arranged between these wall elements 232 and 234 is a wall element 236 that faces away from the vehicle and is connected to the wall elements 232 and 234, for example by weld seams.

In this arrangement, the wall elements 232 and 234 have the greatest deformation resistance to plastic deformation, while the wall element 236 has a lower deformation resistance to plastic deformation.

Preferably, however, the wall element 236 likewise extends between the strut structures 44 of the box structures 24 and 26 and is fixedly connected thereto.

The box body 224 is in particular additionally reinforced by a wall element 238 which faces the vehicle and which likewise extends between the wall element 232 that faces away from the road surface and the wall element 234 that faces the road surface and is fixedly connected to these, but which is arranged facing the vehicle rear 14, at a spacing from the wall element 236 that faces away from the vehicle, and closes off the box body 224 on the side facing the vehicle rear 14.

The wall element 238 facing the vehicle likewise takes the same form as the wall element 236 facing away from the vehicle, and is made from a material having the same deformation resistance to plastic deformation as the wall element 236 facing away from the vehicle.

For optimal utilization of the box body, arranged in a central region of the box body 224 is a mounting flange 242 which is connected both to the wall elements 232 and 234 and also to the wall elements 236 and 238, preferably being fixedly welded thereto, in the region of its outer sides 244 facing the wall elements 232, 234, 236 and 238.

In this arrangement, the mounting flange 242 preferably extends in a flange plane 246 that is inclined at an angle to the vehicle longitudinal center plane 18.

In the absence of a trailer coupling, the mounting flange 242 serves to reinforce the box body 224 in its central region as a result of being connected to the wall elements 232, 234, 236 and 238.

However, the mounting flange 242 also preferably has a mounting opening 238 which enables a pivotal unit 202 to be attached to the mounting flange 242.

Further, the wall element 232 that faces away from the road surface takes the form of a strut structure that has a plurality of openings, for example the openings 252 to 258 of the wall element 232 facing away from the road surface, and strut segments 262, 264 which surround these openings 252 to 258 and which determine the rigidity of the wall element 232 facing away from the road surface as a result of their shape and course.

It is thus possible, as a result of the form taken by the strut segments 262 and 264 and the size of the openings 252 to 258 in relation to one another, to optimize the rigidity of the wall element 232 that faces away from the road surface.

In the same way, the wall element 234 facing the road surface has openings 272, 274, 276 and 278, which are likewise surrounded by strut segments 282, 284.

In particular, however, strut segments 264 and 284 of the wall elements 232, 234 that hold the mounting flange 242 run in an orientation such that they abut against the outer sides 244 of the flange element 242 facing them over the entire surface, and are fixedly connected to these.

Similarly, the wall element 236 facing away from the vehicle and the wall element 238 facing the vehicle have openings 292 to 300 and openings 312 to 320 respectively, which are surrounded by strut segments 322, 324 and 332, 334, wherein strut segments 324 and 334 abutting against the mounting flange 242 abut against the outer sides 244 of the mounting flange 242 facing them over the entire surface, and are fixedly connected to these.

Thus, the mounting flange 242 also serves at the same time to make the entire box body 224 more rigid, by connecting the wall elements 232 and 234, and 236 and 238.

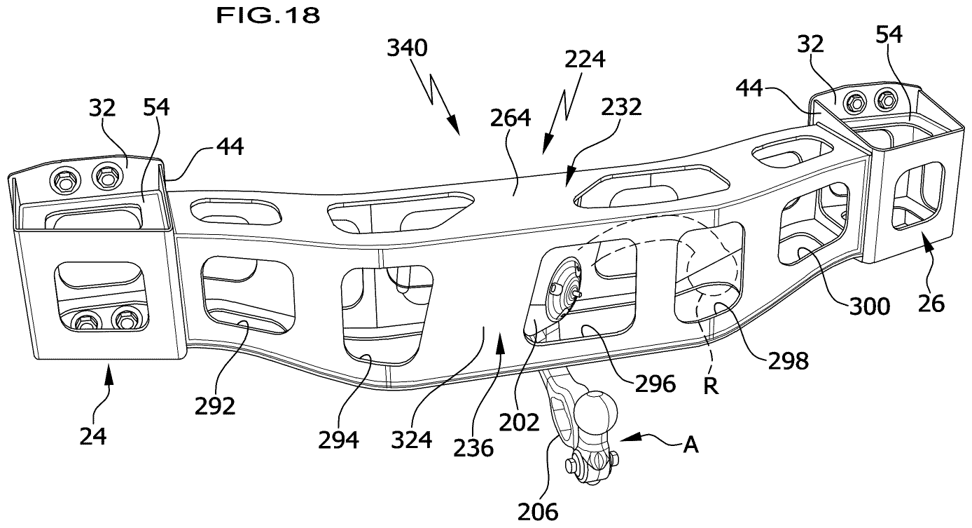

In particular if the intention is to open up the possibility that a pivotal unit 202 for a pivotal ball head 206 is to be arranged on the mounting flange 242, the opening 276 in the wall element 234 that faces the road surface is preferably dimensioned such that the ball head 206 can be moved through it, within the box body 224, from the working position A into the rest position R or within the box body from the rest position R into the working position A, as illustrated in FIG. 18.

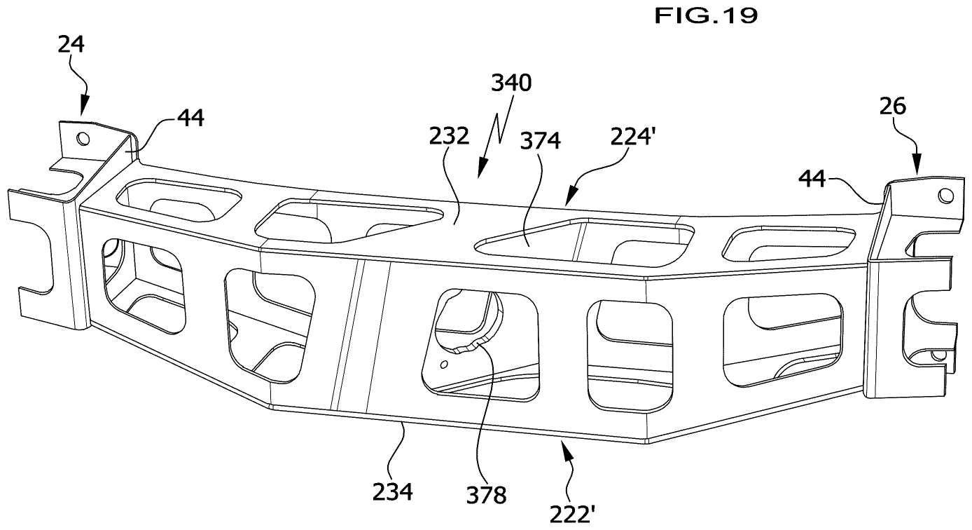

In a fifth variant 340 of the rear impact unit 20 according to the invention, illustrated in FIG. 19, the box body 224′ is likewise formed such that it comprises the wall elements 232 and 234, which take a form identical to that in the variant 220.

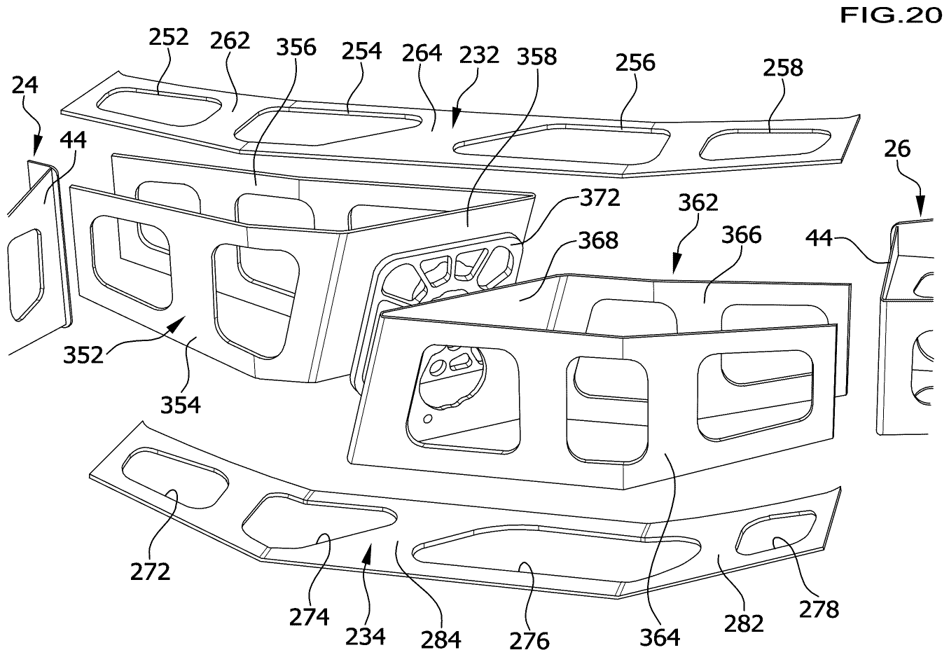

However, as illustrated in particular in FIG. 20, the central carrier 222′ does not comprise a wall element 236 that extends between the box structures 24 and 26, facing away from the vehicle, or a wall element 238 that extends between the box structures 24 and 26, facing the vehicle.

Rather, these wall elements are formed by two U-shaped reinforcement elements 352 and 362.

In this arrangement, the reinforcement element 352 comprises a wall element 354 facing away from the vehicle and a wall element 356 facing the vehicle, which on their sides of the box structure 24″ facing the strut structure 44 are fixedly connected to the strut structure 44 and, at the opposite end to this, are connected in one piece with a mounting flange element 358.

In the same way, the reinforcement element 362 comprises a wall element 364 facing away from the vehicle and a wall element 366 facing the vehicle, both of which, on their sides facing the strut structure 44 of the box structure 26, are fixedly connected to this and, at the opposite end to the strut structure 44, are connected in one piece with one another by a mounting flange element 368.

In this arrangement, the mounting flange elements 358 and 368 are arranged in opposition to one another and are for example connectable directly to one another or are connectable to a mounting plate 372 located between them in order in this way all together to form a mounting flange 374 that has a mounting opening 378, onto which the pivotal unit 202 for a pivotal ball neck 206 is mountable, as illustrated in FIG. 19, wherein the pivotal ball neck 206 is pivotal between a working position A, in which it projects below the central carrier 222′ in opposition to the direction of travel, and a rest position R illustrated in dashed lines, in which the ball neck 206 is located in the box body 224′.

In this variant too, and in the same way as in the foregoing variant, the wall element 232 facing away from the road surface has the openings 252 to 258 that are surrounded by strut segments 262, 264, and the wall element 234 facing the road surface has the openings 272, 274, 276 and 278 that are surrounded by strut segments 282, 284.

Further, the strut segments 264 and 284 adjoining the mounting flange 374 that is formed take a form such that they are connectable to the mounting flange elements 358 and 368 of the reinforcement elements 352 and 362 respectively, in order in this way to provide the box body 224′ with optimal rigidity.

In this arrangement, the wall elements 232 and 234 have the greatest deformation resistance to plastic deformation, while the wall elements 354, 364 and 356 and 366 have a lower deformation resistance to plastic deformation.

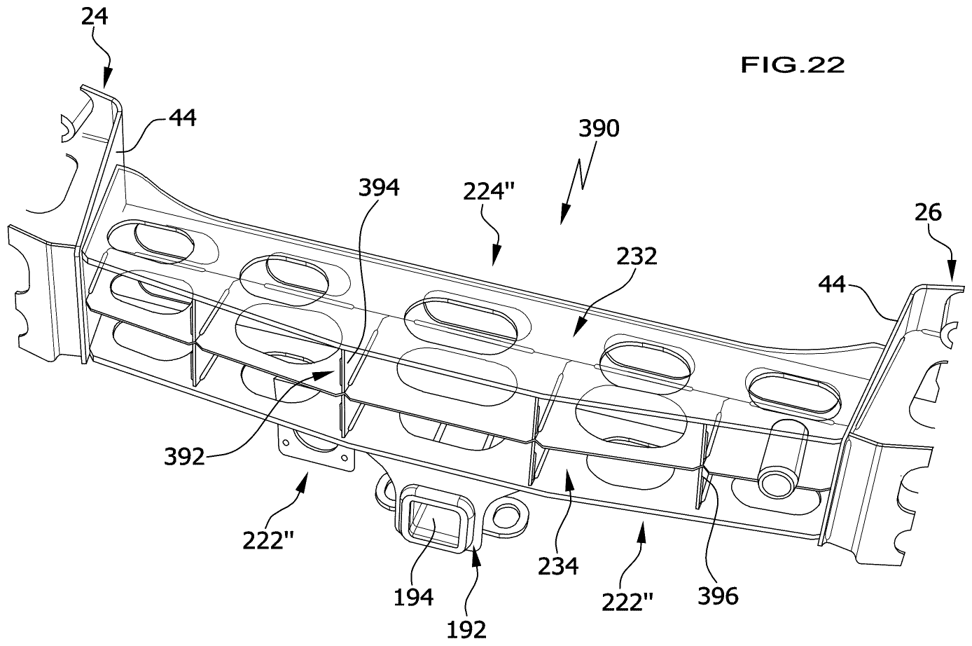

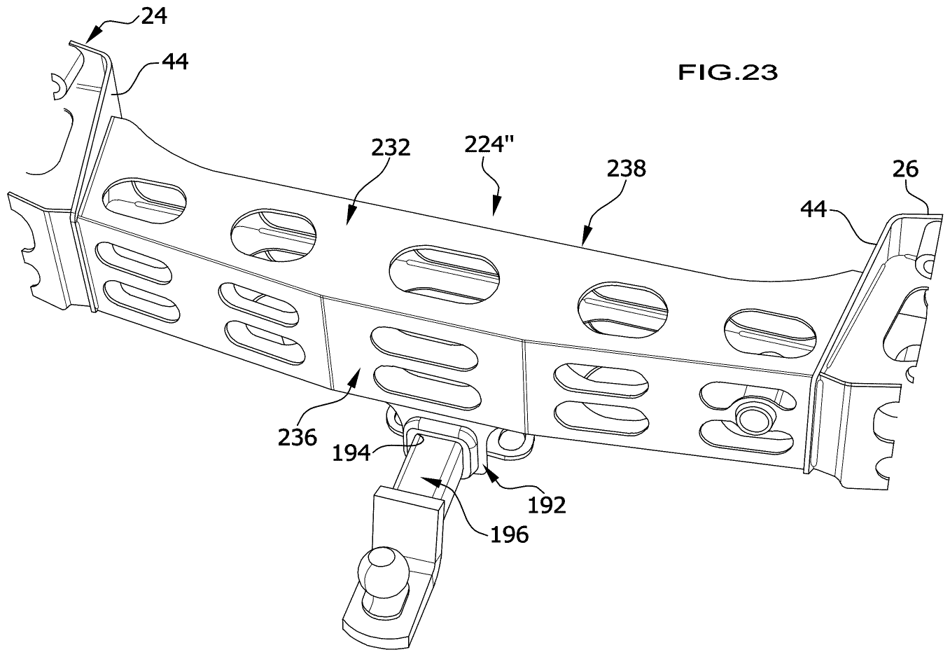

In a sixth variant 390 of the rear impact unit 20 according to the invention, the central carrier 392 likewise comprises a wall element 232 facing away from the road surface and a wall element 234 facing the road surface, which are each connected to the inner strut structure 44 of the box structures 24 and 26 (FIGS. 22, 23).

Located between these wall elements 232 and 234 is a central wall element 392 that extends approximately parallel to them and is likewise connected to the strut structures 44 and 46 of the box structures 24 and 26.

Moreover, the box body 224″, as illustrated in particular in FIG. 23, comprises the wall element 236 that faces away from the vehicle and the wall element 238 that faces the vehicle.

For the purpose of additional reinforcement, also provided between the wall element 232 facing away from the road surface and the central wall element 392 are reinforcement elements 394 connecting these to one another, and between the wall element 234 facing the road surface and the central wall element are additional reinforcement elements 396.

In this arrangement, at least two, preferably four, such reinforcement elements 394 and 396 are arranged at a spacing from one another.

In this case, the central carrier 222″ likewise carries for example a receiving body 192 with a receptacle 194 for an insertion portion 196 (illustrated in FIG. 23), in this case the insertion portion 196 of a coupling element for a trailer.

In the illustrated exemplary embodiment, the receiving body 192 is held against the wall element 234 that faces the road surface.

However, it is also possible to arrange the receiving body 192 between the wall element 232 facing away from the road surface and the wall element 234 facing the road surface, and to make the receptacle 194 accessible through an opening in the wall element 236 facing away from the vehicle.

In this arrangement, the wall elements 232, 234 and 392 have the greatest deformation resistance to plastic deformation, while the wall elements 236, 238 have a lower deformation resistance to plastic deformation.

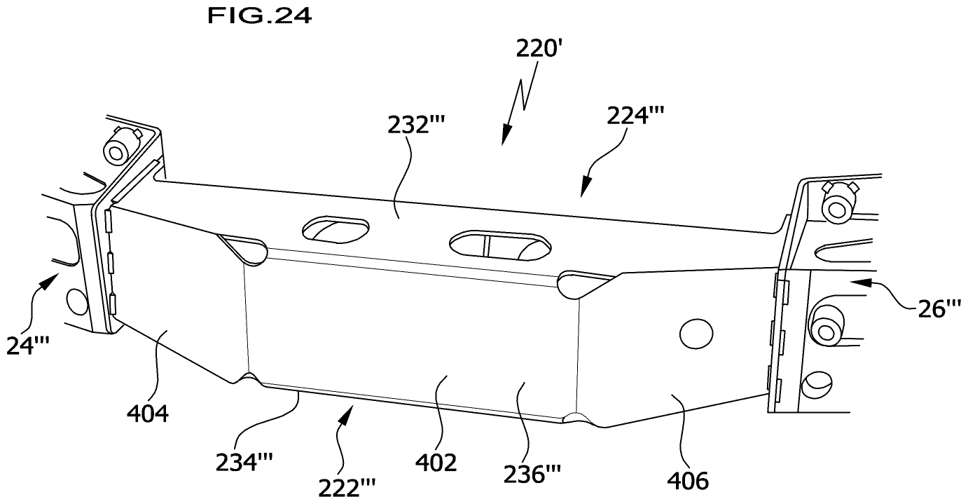

In a seventh variant 220′ of a rear impact unit according to the invention, illustrated in FIG. 24, the central carrier 222″″ differs from the central carrier 22 according to the first exemplary embodiment in that it takes the form of a box body 224″″, wherein the wall element 232″″ facing away from the road surface, the wall element 236″″ facing away from the vehicle and the wall element 234″″ facing the road surface are shaped into a C from a one-piece part, for example a sheet of material, for example by bending, wherein the two limbs of the C are formed by the wall element 232″″ facing away from the road surface and the wall element 234″″ facing the road surface, and the central portion of the C is formed by the element 236″′ facing away from the vehicle.

In particular in this case, a central part 402 of the wall element 236 facing away from the vehicle is connected in one piece with the wall element 232″′ facing away from the road surface and the wall element 234″ facing the road surface, while side parts 404 and 406 located to either side of the central part 402 are welded to the wall element 232″′ facing away from the road surface and the wall element 234″′ facing the road surface, since the wall elements 232″′ and 234″′ taper to either side of the bend 408 from the central part 402 in the direction of the box structures 24 and 26, and thus have an edge 412 and 414 facing away from the vehicle that is increasingly set back in the direction of the box structures 24 and 26, by comparison with the bend 408.

Thus, the side parts 404 and 406 extend in planes that run at an angle in a range of for example 10° to 30° in relation to the central part 402.

In this arrangement, in particular the side parts 404 and 406 are bent in relation to the central part 402 along an edge 416 and 418 respectively, with the result that the wall element 232″′ facing away from the road surface, the wall element 234″′ facing the road surface and the wall element 236″′ facing away from the vehicle are stabilized relative to one another.

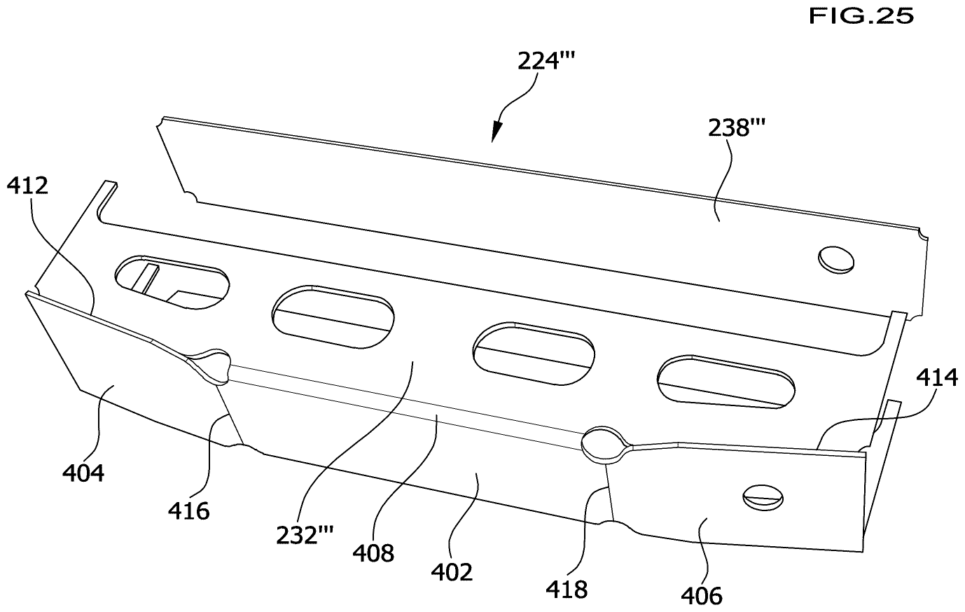

In addition, as illustrated in FIG. 25, the wall element 232″′ facing away from the road surface and the wall element 234″′ facing the road surface are additionally stabilized by a wall element 238″′ that faces the vehicle and is welded to them, with the result that overall a closed box body 224″′ is produced and is adjoined by the respective box structures 24 and 26 according to one of the foregoing exemplary embodiments.

In this arrangement, the wall elements 232″′ and 234″′ have the greatest deformation resistance to plastic deformation, while the wall elements 236″′ and 238″ have a lower deformation resistance to plastic deformation.

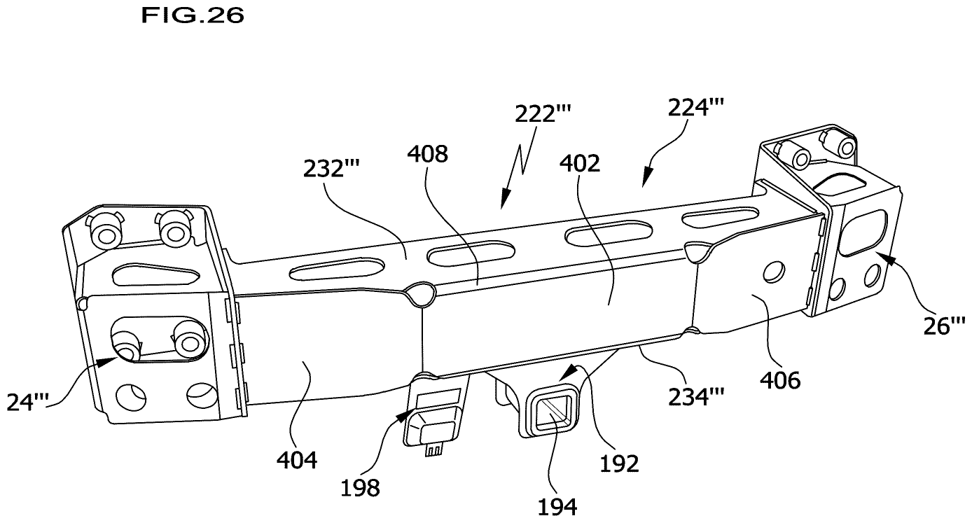

If for example a central carrier 222″′ of this kind is inserted between the box structures 24″′ and 26″′ and connected thereto, it is possible, in the same way as already explained in connection with FIG. 13, to arrange a receiving body 192 on the central carrier 222″′, of which the receptacle 194 is suitable for an insertion portion 196 of a coupling element for a trailer or a load carrier (FIG. 26), wherein the receptacle 192 may either be fixedly connected to the central carrier 222″′ or mounted to be movable relative thereto.

Moreover, it is also possible to provide a plug socket 198 next to the receiving body 192.

In this arrangement, the receiving body 192 is preferably held on the wall element 234″′ that faces the road surface, as illustrated in FIG. 26.

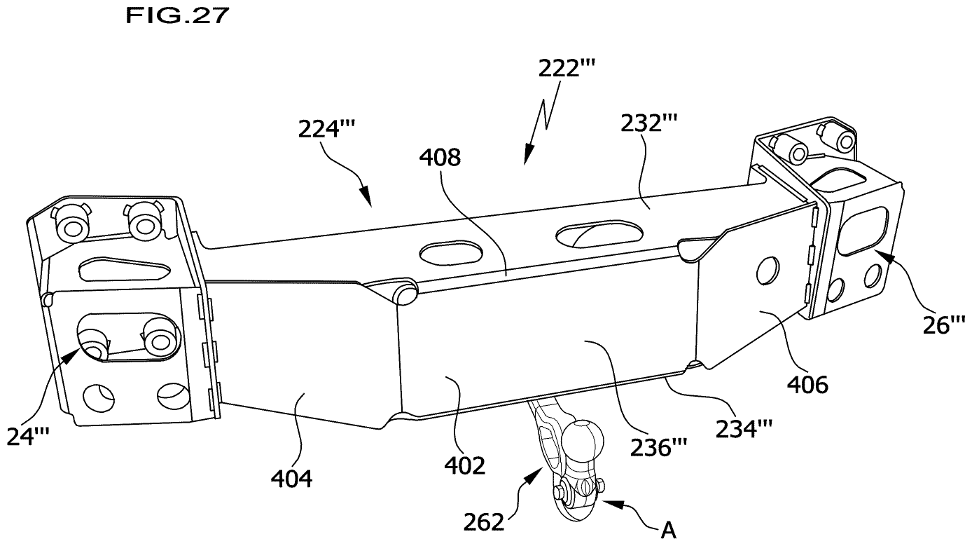

In a further exemplary embodiment of the central carrier 222″′, it is possible to provide a pivotal ball neck 206 that is pivotal from a working position A into a rest position R located within the central carrier 222″′ and thus within the box body 224″′ (FIG. 27).

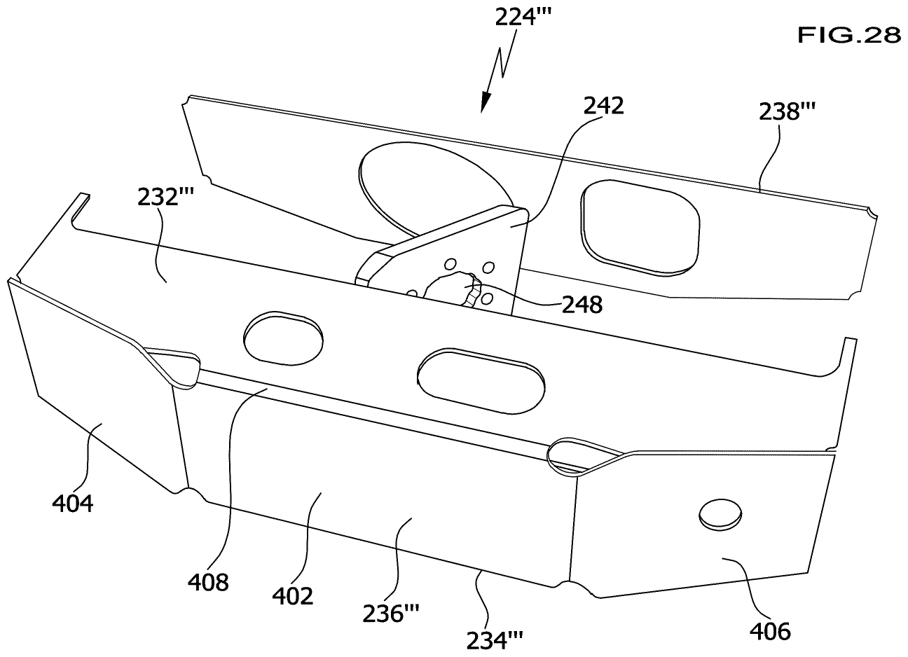

For the purpose of mounting the pivotal ball neck 206, the mounting flange 242 is arranged in the box body 224″′ itself, as illustrated in FIG. 28, and at the same time serves to make the box body 224″′ more rigid, wherein the mounting flange 242 is connected by a weld connection to the wall element 232″′ facing away from the road surface, the wall element 234″′ facing the road surface, the wall element 236″′ facing away from the vehicle and the wall element 238″′ facing the vehicle, and moreover thus contributes to making the box body 224″′ more rigid.

As regards further features of this exemplary embodiment, reference is made to the statements relating to the foregoing exemplary embodiments in their entirety.

In this connection, arranged on this mounting flange 242 is the pivotal unit 202 for the pivotal ball neck 206, in the same way as described in connection with the exemplary embodiment according to FIG. 17 and FIG. 18.

Further, as for example described and illustrated in the drawing in connection with the exemplary embodiment according to FIG. 17, the wall element 234″′ facing the road surface is also provided with the opening 276, which makes it possible to move the pivotal ball neck 206 into the box body 224″′ for the purpose of moving it in the rest position.

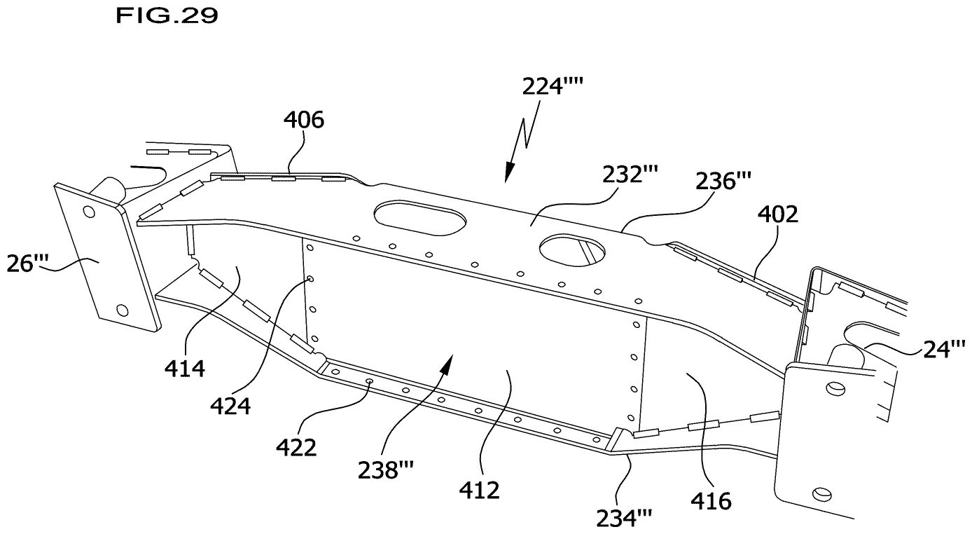

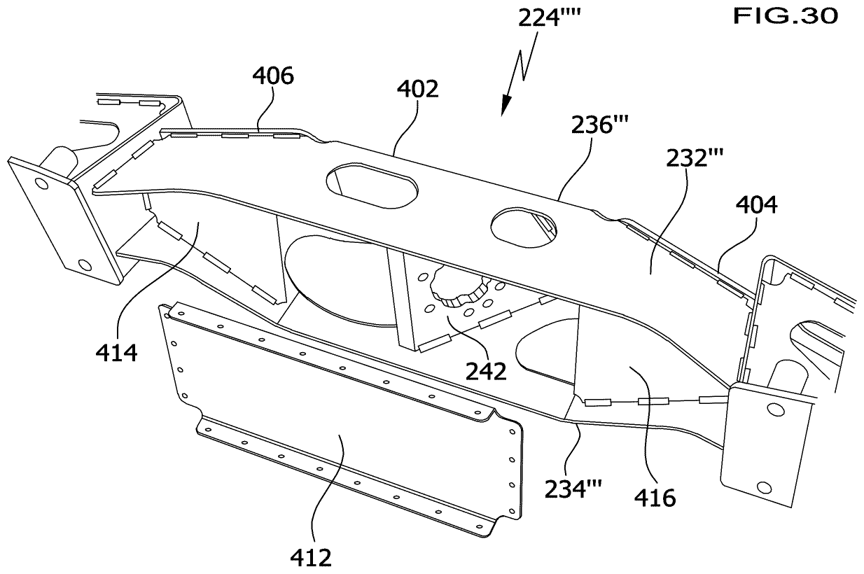

In an eighth variant of the rear impact unit, illustrated in FIGS. 29 and 30, the box body 224″″ is likewise formed from the wall element 232″′ that faces away from the road surface and the wall element 234″′ that faces the road surface and the wall element 236″′ that faces away from the vehicle, as explained in connection with the two foregoing exemplary embodiments.

However, the element 238″″ that faces the vehicle is not formed from one piece but from a central part 412 and two side parts 414 and 416, wherein the side parts 414 and 416 are each welded to the wall element 232″′ that faces away from the road surface and the wall element 234″′ that faces the road surface, while the central part 412 is connected both to the wall element 232″′ that faces away from the road surface and to the wall element 234″′ that faces the road surface by individual connection elements 422, and moreover is connected to the side parts 414 and 416 by connection elements 424.

This solution provides the possibility that the box body 224″″ takes a form such that first the side parts 414 and 416 are each fixedly connected to the wall element 232″′ that faces away from the road surface and the wall element 234″′ that faces the road surface, and there is then the option to insert and weld the mounting flange 242 between the wall element 232″′ that faces away from the road surface and the wall element 234″′ that faces the road surface, and where appropriate also to mount the pivotal unit 202 with the pivotal ball neck 206 on the mounting flange 242, and subsequently to insert the central part 412 and to connect it both to the wall element 232″′ that faces away from the road surface and the wall element 234″′ that faces the road surface using the connection elements 422 and where appropriate also to connect the central part 412 to the side parts 414 and 416, in order in this way to achieve additional reinforcement of the box structure 224″″.

In this arrangement, the wall elements 232″′ and 234″′ have the greatest deformation resistance to plastic deformation, while the wall elements 236″′ and 238″′ have a lower deformation resistance to plastic deformation.

1. A rear impact unit, which is mounted or mountable on a vehicle rear in a manner hidden by a bumper unit, and which extends transversely to a vehicle longitudinal direction and transversely to a vehicle longitudinal center plane, wherein the rear impact unit comprises two box structures, which are arranged at a spacing from one another, and a central carrier, which is arranged between these and connects them to one another, wherein as a result of fixing the box structures on the vehicle rear a transverse carrier unit comprising the central carrier and box structures is mountable, and wherein the box structures are supported against the vehicle rear by mounting elements that are mountable thereon and carry the transverse carrier unit, which is deformable in the event of a crash.

2. The rear impact unit as claimed in claim 1, wherein the central carrier is fixedly connected to the box structures, and wherein in particular forces acting on it are introduced into the box structures and where appropriate from these into the vehicle rear.

3. The rear impact unit as claimed in claim 1, wherein the mounting element has a supporting face that is adapted to a mounting face of the vehicle rear.

4. The rear impact unit as claimed in claim 1, wherein the mounting element has a plurality of cohesive support segments that form the supporting face.

5. The rear impact unit as claimed in claim 1, wherein each box structure has an impact element which faces away from the mounting element.

6. The rear impact unit as claimed in claim 5, wherein the respective impact element is formed by cohesive impact segments.

7. The rear impact unit as claimed in claim 1, wherein the box structures each have strut elements which are arranged between the impact element and the mounting element.

8. The rear impact unit as claimed in claim 7, wherein the box structures each have at least two strut elements, which run at a spacing from one another between the impact element and the mounting element.

9. The rear impact unit as claimed in claim 7, wherein at least one of the strut elements faces and is connected to the central carrier.

10. The rear impact unit as claimed in claim 7, wherein at least one of the strut elements runs transversely to the direction of extent of the central carrier.

11. The rear impact unit as claimed in claim 7, wherein the box structures have at least two strut elements which are arranged at a spacing from one another and which run transversely to the direction of extent of the central carrier.

12. The rear impact unit as claimed in claim 1, wherein the box structures have at least one strut element that runs approximately parallel to the direction of extent of the central carrier.

13. The rear impact unit as claimed in claim 12, wherein each of the box structures has at least two strut elements which are arranged at a spacing from one another and which run approximately parallel to the direction of extent of the central carrier.

14. The rear impact unit as claimed in claim 1, wherein the mounting element has a greater deformation resistance to plastic deformation than all the strut elements of the box structures.

15. The rear impact unit as claimed in claim 14, wherein at least one of the strut elements that run transversely to the direction of extent of the central carrier has a greater deformation resistance to plastic deformation than at least one of the strut elements that run approximately parallel to the direction of extent of the central carrier.

16. The rear impact unit as claimed in claim 14, wherein at least one of the strut elements that run transversely to the direction of extent of the central carrier has a greater deformation resistance to plastic deformation than at least one of the strut elements that run approximately parallel to the direction of extent of the central carrier.

17. The rear impact unit as claimed in claim 1, wherein the impact element has a lower deformation resistance to plastic deformation than the mounting element.

18. The rear impact unit as claimed in claim 1, wherein the impact element has a lower deformation resistance to plastic deformation than the at least one strut element that extends transversely to the direction of extent of the central carrier.

19. The rear impact unit as claimed in claim 1, wherein at least one of the strut elements has strut segments extending around an aperture.

20. The rear impact unit as claimed in claim 19, wherein each strut element has strut segments extending around an aperture.

21. The rear impact unit as claimed in claim 1, wherein the mounting element has planar support segments that extend around an aperture.

22. The rear impact unit as claimed in claim 1, wherein the impact element has planar impact segments that extend around an aperture.

23. The rear impact unit as claimed in claim 1, wherein the strut element that carries the central carrier is connected in one piece with the mounting element.

24. The rear impact unit as claimed in claim 1, wherein the central carrier is connected to the strut segments of the strut element carrying it by at least one of i) positive locking and ii) substance-to-substance bond.

25. The rear impact unit as claimed in claim 1, wherein the mounting element has a greater surface extent than the impact element.

26. The rear impact unit as claimed in claim 7, wherein the strut segments of the strut elements that extend between the impact element and the mounting element are connected to regions of the mounting element in which there are located mounting points for fixing the respective mounting element to the vehicle rear.

27. The rear impact unit as claimed in claim 7, wherein the mounting element is connected in one piece with at least one strut element.

28. The rear impact unit as claimed in claim 7, wherein the impact element is connected in one piece with at least one strut element.

29. The rear impact unit as claimed in claim 7, wherein the strut elements surround a cavity located between the impact element and the mounting element.

30. The rear impact unit as claimed in claim 1, wherein the central carrier is a part that extends between the box structures and is similar to a tube or takes the form of a profile element.

31. The rear impact unit as claimed in claim 1, wherein the central carrier takes the form of a box body.

32. The rear impact unit as claimed in claim 31, wherein the central carrier has a wall element that faces away from the road surface and a wall element that faces the road surface.

33. The rear impact unit as claimed in claim 31, wherein the central carrier has a wall element which faces away from the road surface and which extends between and is connected to the box structures.

34. The rear impact unit as claimed in claim 31, wherein the central carrier has a wall element which faces the road surface and which extends between and is connected to the box structures.

35. The rear impact unit as claimed in claim 31, wherein the central carrier has a wall element which faces away from the vehicle and which extends between the box structures.

36. The rear impact unit as claimed in claim 31, wherein the central carrier has a wall element which faces the vehicle and which extends between the box structures.

37. The rear impact unit as claimed in claim 31, wherein the wall element that faces away from the vehicle and the wall element that faces the vehicle are connected to one another by a connection part located centrally between the box structures.

38. The rear impact unit as claimed in claim 31, wherein the wall element that faces away from the vehicle is formed from two wall element parts.

39. The rear impact unit as claimed in claim 31, wherein the wall element that faces the vehicle is formed from two wall element parts.

40. The rear impact unit as claimed in claim 37, wherein at least one wall element part that faces the vehicle and one wall element part opposite this that faces away from the vehicle are connected by a connection element which extends between them and reinforces these wall element parts relative to one another, at a spacing from the box structures.

41. The rear impact unit as claimed in claim 40, wherein the wall element part that faces the vehicle and the wall element part that faces away from the vehicle and the connection element are connected in one piece with one another.

42. The rear impact unit as claimed in claim 40, wherein both wall element parts facing the vehicle and the wall element parts facing away from the vehicle which respectively face these are in each case connected to one another by a connection part.

43. The rear impact unit as claimed in claim 42, wherein the connection parts abut against one another.

44. The rear impact unit as claimed in claim 42, wherein the connection parts form a mounting flange for a trailer coupling.

45. The rear impact unit as claimed in claim 31, wherein the wall element parts that face away from the vehicle and the wall element parts that face the vehicle are connected to one another by at least one of i) a wall element facing away from the road surface and ii) a wall element facing the road surface.

46. The rear impact unit as claimed in claim 31, wherein at least one, in particular a plurality of reinforcement elements runs transversely between the wall element facing away from the road surface and the wall element facing the road surface.

47. The rear impact unit as claimed in claim 31, wherein a central wall element is arranged between the wall elements that face the road surface and face away from the road surface, and the wall elements that face the vehicle and face away from the vehicle.

48. The rear impact unit as claimed in claim 46, wherein at least one, in particular a plurality of reinforcement elements runs transversely to the wall elements that face away from the road surface and face the road surface, and the central wall element.

49. The rear impact unit as claimed in claim 31, wherein at least one of the wall elements comprising the wall element facing away from the road surface and the wall element facing the road surface, and at least one of the wall elements comprising the wall element facing away from the vehicle and the wall element facing the vehicle, are made from one sheet of material and connected in one piece with one another, at least in certain regions.

50. The rear impact unit as claimed in claim 49, wherein at least three of the wall elements are made from one sheet of material and are connected in one piece with one another, at least in certain regions.

51. The rear impact unit as claimed in claim 49, wherein at least one of the wall elements takes a multi-part form and has a central part and side parts.

52. The rear impact unit as claimed in claim 51, wherein the side parts are fixedly connected, in particular welded, to two mutually opposing wall elements.

53. The rear impact unit as claimed in claim 51, wherein one of the central parts is connected in one piece with at least one of the wall elements adjoining it.

54. The rear impact unit as claimed in claim 51, wherein the side parts run outside a plane predetermined by the central part.

55. The rear impact unit as claimed in claim 54, wherein the side parts are bent in relation to the central part.

56. The rear impact unit as claimed in claim 51, wherein the side parts are connected in one piece with one of the central parts.

57. The rear impact unit as claimed in claim 51, wherein at least one of the central parts is connected to the side parts by positively locking elements.

58. The rear impact unit as claimed in claim 51, wherein at least one of the central parts is connected to at least one of the wall elements by positively locking elements.

59. The rear impact unit as claimed in claim 31, wherein the wall element that faces away from the road surface and the wall element that faces the road surface have a greater deformation resistance to plastic deformation than the wall element that faces away from the vehicle and the wall element that faces the vehicle.
